(19) United States
(12) Patent Application Publication
(10) Pub. No.: US 2025/0201855 A1
(43) Pub. Date: Jun. 19, 2025

(54) SOLVENT-FREE PROCESS FOR PREPARING LITHIUM-ION BATTERIES

(71) Applicant: Cabot Corporation, Boston, MA (US)

(72) Inventors: Olha Mashtalir, N. Billerica, MA (US); Peter Aurora, Lexington, MA (US); Toivo T. Kodas, Carlisle, MA (US); Jeffrey Marchesano, Nashua, NH (US)

(21) Appl. No.: 18/847,930

(22) PCT Filed: Mar. 17, 2023
(86) PCT No.: PCT/US2023/064614

§ 371 Date: Sep. 17, 2024

Related U.S. Application Data
(60) Provisional application No. 63/322,074, filed on Mar. 21, 2022.

(51) Int. Cl. H01M 4/62; H01M 4/02; H01M 4/04; H01M 4/131; H01M 4/133; H01M 4/1391; H01M 4/1393; H01M 4/505; H01M 4/525; H01M 4/587; H01M 10/0525

(52) U.S. Cl. CPC H01M 4/625; H01M 4/0435; H01M 4/131; H01M 4/133; H01M 4/1391; H01M 4/1393; H01M 4/505; H01M 4/525; H01M 4/587; H01M 4/623; H01M 10/0525; H01M 2004/021

(57) ABSTRACT

A solvent-free process employs a multifunctional carbon black to prepare compositions and electrodes for lithium-ion batteries. The multifunctional carbon black provides two or more desirable characteristics, acting, for example, as a conductive carbon additive, as a fibrillizing agent and/or as a mechanical reinforcement. In one example, an electroactive material, e.g., graphite or a lithium transition metal compound, a binder and a multifunctional carbon black are combined in one or more steps. High shear mixing is used to process the binder in the presence of the multifunctional carbon black. The resulting composition can be formed into a film which can be applied onto a suitable substrate to produce an electrode.

### RELATED APPLICATIONS

This application claims the benefit under 35 USC 119 (e) of U.S. Provisional Application No. 63/322,074, filed on Mar. 21, 2022, which is incorporated herein by reference in its entirety.

### GOVERNMENT SUPPORT

This invention was made with Government support under Award Number DE-EE0009109.0000, awarded by the Office of Energy Efficiency and Renewable Energy (EERE) of the U.S. Department of Energy. The Government has certain rights in the invention.

### BACKGROUND OF THE INVENTION

Lithium-ion batteries (LIBs) are commonly used sources of electrical energy for numerous applications ranging from electronic devices to electric vehicles. A lithium-ion battery typically includes a negative electrode and a positive electrode in an arrangement that allows lithium ions and electrons to move to and from the electrodes during charging and discharging. An electrolyte solution in contact with the electrodes provides a conductive medium in which the ions can move. To prevent direct reaction between the electrodes, an ion-permeable separator is used to physically and electrically isolate the electrodes. During operation, electrical contact is made to the electrodes, allowing electrons to flow through the device to provide electrical power, and lithium ions to move through the electrolyte from one electrode to the other.

Most commercially available lithium-ion batteries have anodes that contain graphite, a material capable of incorporating lithium through an intercalation mechanism. Typically, lithium is added to the graphite anode during the charging cycle and removed as the battery is used. Other anode materials used in addition to or alternatively to graphite include lithium titanate, tin oxide, silicon (Si) and SiOₓ (with x typically being 1.04, 1.06, etc.).

Cathodes typically include a conductive substrate supporting a mixture containing at least an electrochemically active material and a binder. The electroactive material, such as a lithium transition metal oxide, is capable of receiving and releasing lithium ions. As with the anode, the binder is used to provide mechanical integrity and stability to the electrode.

Since the electroactive material and the binder often display poor electrically conducting or even insulating properties, cathodes often include an additive component which enhances the electrical conductivity of the electrode. Conductive additives, carbon conductive additives, for instance, also can be found in LIB anode compositions.

To manufacture the electrode, the active electrode material, graphite for instance, is mixed with a binder, typically a polymeric or resin material. Many existing fabrication methods employ casting techniques based on wet slurries that contain not only the binder but also solvents, plasticizers, conducive additives, and so forth. During manufacturing, the slurry is coated or extruded onto a conductive substrate. Since the solvent is detrimental to the final product, it is removed by drying.

However, drying operations, in particular those aimed at solvent removal, require time, slowing down the overall production process. Also, they can raise costs as well as environmental concerns, typically due to the toxicity of the solvent, e.g. NMP. In terms of the end product, the removal of the solvent during the drying process often leads to migration of the binder to the surface of the electrode. Though minimal migration can be acceptable in some cases, it is problematic in others. For high loadings (thick, >4.5 mAh/cm²) electrodes, for instance, the migration is exacerbated, leading to delamination and poor electrode performance.

As a result, “dry” alternatives, aiming at reducing or eliminating the drying step associated with slurry techniques, are being developed. While dry processes also produce electrodes that typically contain an electroactive material, binder and a conductive additive component, they do not require using a solvent.

Dry approaches that have been proposed include high shear mixing involving a fibrillizable binder, use of sacrificial binders to be removed upon processing of the electrode, dry powder spraying, electrostatic spray deposition, cold plasma deposition, sputtering deposition, powder printing, to name a few. In some, a fibrillization promoter is incorporated into the binder and the resulting formulation is subjected to high shear mixing to fibrillate the binder, thereby generating a web-like structure that can better hold the materials together and support the active material.

To date, the most common additive used to promote binder fibrillization has been activated carbon (AC). Generally, AC is derived from carbonaceous source materials such as bamboo, coconut husk, willow peat, wood, coir, lignite, coal, and petroleum pitch. Activation is achieved by physical or chemical approaches, as known in the art. For many applications, AC powders are milled to tens of micron (μm) particle dimensions prior to activation.

### SUMMARY OF THE INVENTION

While dry manufacturing processes have the potential of eliminating many of the challenges posed by the addition and/or removal of solvents (often harmful), problems remain.

For example, current “dry” fabrication techniques utilize not only the active electrode material but many other ingredients such as fibrillization promoters, conductive additives and binders. Since many of these components are not involved in the electrochemical reactions that generate electrical energy, they can negatively affect certain performance characteristics (e.g., capacity and energy density) of the battery, as they effectively lower the amount of active material that can be contained in a given volume.

State of the art fibrillization agents such as ACs often contain high impurity levels. Also, high surface areas and surface oxygen-containing groups that are typical for ACs tend to promote significant water uptake. These features can contribute to irreversible capacity losses, diminishing battery performance. Furthermore, ACs fail to add sufficient conductivity, raising the need for increased amounts of conductive additives in the overall formulation. Even as a simple fibrillization promoter, AC often requires relatively high loadings (5 to 10 weight %, in many cases) and this, in and of itself, also limits the amount of active materials that can be included.

A need exists, therefore, for compositions and processes that address at least some of the problems associated with existing approaches.

In general, the invention relates to the use of certain carbon blacks to bring about needed improvements in the fabrication method, product electrode and/or assembled battery. More specifically, the invention relates to the use of these materials in the context of dry or solvent-free electrode manufacturing processes.

The carbon blacks have selected morphologies and/or surface chemistries and can provide two or more functions in the context of dry (solvent-free) electrode fabrication methods. For example, multifunctional carbon blacks described herein can act as a fibrillizing agent, serving as an AC substitute; as a conductive carbon additive; and/or as a mechanical reinforcement (or, in other words, as binding aid, adding mechanical strength and flexibility to a product electrode).

In general, a “multifunctional” carbon black (CB) can be defined as a CB that effectively deforms or fibrillizes a binder employed in a solvent-free process; contributes to the electronic/ionic conductivity of the electrode; and/or provides mechanical benefits. In specific implementations, a multifunctional CB can be thought of as being capable of fibrillizing a fibrillizable binder at a loading no greater than 5 weight percent (wt %). At this loading, the multifunctional CB also acts as a carbon conductive additive, reducing the in-plane resistivity of the electrode. In many cases, mechanical benefits are obtained as well.

For many dry processes, the multifunctional CB has a BET that is no greater than about 1600 m²/g, e.g., from about 35 to about 1600 m²/g, and an OAN that is no greater than about 650 ml/100 g, e.g., within a range of from 120 to about 650 ml/100 g.

Other desirable CB attributes may include a high surface roughness (with macroporosity close to the particle surface), good electronic conductivity (with powder resistivity of about 1.0 Ohm cm or less, measured at compressed density of 0.5 g/cm³).

Further to the BET and OAN properties mentioned above, many multifunctional CBs that can be utilized are characterized by one or more of the following: a surface energy of about 15 mJ/m² or less, a Raman microcrystalline planar size (La) of at least about 17 Å, a mesopore volume of at least about 0.1 cm³/g and a macropore volume of at least about 0.2 cm³/g. A total mesopore and macropore volume can be at least about 1 cm³/g.

For some anode applications, the solvent-free process employs a CB having a BET of about 35 to about 1600 m²/g, such as within a range of from about 55 to about 200 m²/g, and an OAN of about 120 to about 650 ml/100 g, such as within a range of from about 130 to about 240 ml/100 g. In further examples, the CB has one or more of the following properties: a surface energy of about 15 mJ/m² or less, a Raman microcrystalline planar size (La) of at least about 17 Å, a mesopore volume of at least about 0.1 cm³/g (e.g., from about 0.1 to about 0.25 cm³/g) and a macropore volume of at least about 0.1 cm³/g (e.g., from about 0.1 to about 0.4 cm³/g). A total mesopore and macropore volume can be at least about 0.2 cm³/g (e.g., from about 0.2 to about 0.8 cm³/g).

For some cathode applications, the solvent-free process employs a carbon black having a BET of about 35 to about 1600 m²/g, such as within a range of from about 500 to about 1600, and an OAN of about 120 to about 650 ml/100 g, such as within a range of from about 250 to about 650 ml/100 g. In further examples, the CB has one or more of the following properties: a surface energy of about 15 mJ/m² or less, a Raman microcrystalline planar size (La) of at least about 17 Å, a mesopore volume of at least about 0.1 cm³/g (e.g., at least about 0.35 cm³/g) and a macropore volume of at least about 0.2 cm³/g (e.g., at least about 0.4 cm³/g). A total mesopore and macropore volume can be at least about 1 cm³/g.

In many embodiments, the method described herein is conducted without adding any liquid (typically any solvent). Ingredients are provided as loose particulate materials such as flowing or pourable powders, flakes, beads, granules, pellets and so forth.

However, it is possible, in some cases, to use small amounts of liquid (solvent, for instance) to carry out the method described herein, typically a step other than the fibrillating step. Generally, if liquid is being added, amounts employed are no greater than about 10 wt % of the total amount of ingredients used. In many situations, liquid, e.g., solvent, is added in an amount that is no greater than 1 wt %.

One aspect of the invention features a method for preparing an electrode composition. The method includes combining an active electrode material, a binder and a multifunctional carbon black, e.g., the multifunctional carbon black described herein, and processing the binder in the presence of the multifunctional carbon black. Many implementations of this method are conducted without liquid (typically a solvent) addition.

In general, the binder can be any semi-crystalline polymer. Accordingly, the method can be conducted with binders conventionally thought as “fibrillizable” as well as with those conventionally considered as “non-fibrillizable” binders; combinations thereof also can be utilized.

In one illustration, a method for preparing an electrode composition comprises: combining an active electrode material, a fibrillizable binder and a multifunctional carbon black, e.g., one having a BET no greater than about 1600 m²/g and an OAN no greater than about 650 ml/100 g, and subjecting the binder to a fibrillization operation in the presence of the multifunctional carbon black.

Another aspect of the invention features a method for preparing an electrode composition. The method comprises processing a binder (subjecting the binder to high shear conditions, for example) in the presence of a multifunctional carbon black, having properties such as described above, and adding an electrode active material before, during or after binder processing. The binder can be a fibrillizable binder, a non-fibrillizable binder or any combination thereof.

In specific embodiments, the method described herein is conducted without adding any fibrillating aid other than the multifunctional carbon. In such a case, the carbon black employed provides the entire binder processing (e.g., fibrillating) functionality, completely replacing conventional fibrillating agents such as activated carbons, for instance. In addition to employing a binder processing (e.g., fibrillating) component that consists of a multifunctional carbon black such as described herein, it is also possible to use a binder processing component that consists essentially of or that comprises the multifunctional carbon black. Thus, in some examples, the multifunctional carbon black is used in combination with various amounts of a conventional fibrillizing aid, an activated carbon, for example. It is also possible to combine a multifunctional CB with another multifunctional CB, and/or with a conventional conductive carbon additive (CCA).

The electroactive material, the binder, e.g., a fibrillizable binder, and the multifunctional CB can be combined in a single step, the binder processing, a fibrillization operation, for instance, being conducted subsequently. In other embodiments, the constituents are combined sequentially. For example, the binder, in the presence of the multifunctional additive, is processed, e.g., fibrillized, first, this step being followed by mixing with the electroactive material. Other sequences are possible. Uniform distributions of constituents can be obtained using conditions other (often milder) than those utilized in the binder processing, e.g., fibrillization. Low shear mixing techniques also can prevent particle fragmentations and preserve particle size.

The resulting electrode composition, typically a loose particulate material such as a flowing powder, containing electroactive material, processed (e.g., fibrillated) binder, multifunctional CB and, optionally, other ingredients, can be further processed. For example, the composition can be formed into a free-standing film that can be applied to an electrically conductive substrate or support to form an electrode. In one approach, the composition is calendered and laminated to a conductive foil substate. The calendering operation can be conducted at or above room temperature, e.g., at a temperature similar or close to the polymer glass transition temperature. The lamination step can be performed during or after the composition is calendered. The resulting product electrode can be assembled into a LIB battery in which one or both electrodes is/are prepared by a solvent-free process. In one example, both electrodes are prepared according to techniques described herein.

In a further aspect, the invention features a dry processed film which includes an active electrode material; a binder, typically processed, e.g., fibrillized; and a multifunctional carbon black. Before any drying operation, the dry processed film has a weight that is the same as or within 1 wt % of its theoretical weight. The multifunctional carbon black has a BET no greater than about 1600 m²/g and an OAN no greater than about 650 ml/100 g. In some examples, the multifunctional carbon black also has at least one of the following properties: a surface energy of 15 mJ/m² or less, a Raman microcrystalline planar size (La) of at least 17 Å, a mesopore volume of at least 0.35 cm³/g, and a macropore volume of at least 0.2 cm³/g. A total mesoporous and microporous volume can be at least about 1 cm³/g.

In one implementation, the electrode prepared by techniques described herein has an in-plane resistivity that is no greater than that characterizing a reference electrode prepared using AC.

Practicing embodiments of the invention has many advantages. Using a multifunctional CB, for example, can reduce the amount of binder and/or conventional processing additives required in the fabrication process, increasing the potential loading with active materials and leading to higher energy density electrodes and therefore batteries. Approaches described herein can reduce or eliminate the need for ACs. In many cases, smaller additive amounts are needed, increasing the available content allowed for active electrode materials, yielding batteries with higher energy densities and longer lifetimes. The CB multifunctional additive can improve binder fibrillization and material distribution across the electrode. Enhanced adhesion and mechanical stability represent yet other potential benefits. Dry-processed electrodes prepared using the carbon blacks described herein exhibit good charge transfer. The reduction in electrode impedance expected with a multifunctional CB additive can improve cell rate capacity and charging performance, opening opportunities for thicker electrodes and higher energy density batteries with fast charging capabilities.

Whereas binder migration phenomena are often observed with slurry-prepared electrodes, the process and composition described herein appear to yield uniform distributions across the electrode. The fibrillated binder keeps the electroactive particles (along with the conductive additives) together (cohesion), while also keeping the electrode film layer attached to the metal substrate (adhesion).

The solvent-free techniques described herein reduce or eliminate the use of harmful solvents such as N-methyl-2-pyrrolidone (NMP) and the like. Being able to bypass the drying step associated with slurry (or other “wet” processes) can simplify, speed up manufacture and reduce the footprint of the electrode production line. These benefits, as well as reducing or eliminating the need for solvent recycling or emissions abatement measures can contribute to overall cost reductions.

In some embodiments, the dry process can be carried out using a binder that is not conventionally thought as a fibrillizable binder, thus expanding production options.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are SEM images (low and high magnification) of cross section of a reference (comparative) electrode prepared by a dry process using activated carbon (AC);

FIG. 1C is an elemental fluorine map across the electrode of FIG. 1A;

FIGS. 1D and 1E are SEM images (low and high magnification) of cross sections of an electrode prepared by a dry process using an unmodified CB additive;

FIG. 1F is an elemental fluorine map across the electrode of FIG. 1D;

FIGS. 1G and 1H are SEM images (low and high magnification) of cross sections of an electrode prepared by a dry process in which the CB used was a heat treated version of the CB of FIGS. 1C and 1D;

FIG. 1I is an elemental fluorine map across the electrode of FIG. 1G;

FIG. 2 presents the in-plane resistivity of the electrodes of FIGS. 1A and 1B (reference); FIGS. 1D and 1E (unmodified CB); and FIGS. 1G and 1H (heat-treated CB);

FIG. 3 compares the tensile strength for the free-standing graphite electrode film and in-plane resistivity for a reference graphite electrode prepared by a dry process using activated carbon and graphite electrodes prepared by a dry process using several CB specifications sorted by BET surface area parameter;

FIG. 4 compares the tensile strength and elastic modulus for a reference free-standing NCM electrode film prepared by a dry process using activated carbon and NCM electrode films prepared by a dry process using several CB specifications at 5 wt. % loading in the formulation;

FIG. 5 compares the tensile strength and elastic modulus for free-standing NCM electrode films prepared by a dry process using several CB specifications at 2 wt. % loading in the formulation;

FIG. 6 compares the in-plane resistivity for a reference NCM electrode prepared by a dry process using activated carbon and NCM electrode prepared by a dry process using selected CBs.

FIG. 7 compares the tensile strength and elastic modulus for free-standing NCM electrode films prepared by a dry process using CB specifications at 1 wt. % loading in the formulation where the CB material is in fluffy and pelletized forms.

FIG. 8 is a plot showing 0.2C, 0.5C, 1C, 2C, and 3C discharge capacity of full coin cells having NCM622 cathodes using conductive additives disclosed herein.

FIG. 9 is a plot showing C/20 discharge capacity of full coin cells having NCM622 cathodes using conductive additives disclosed herein.

FIG. 10 is a plot showing the first cycle irreversible capacity of full coin cells having NCM622 cathodes using conductive additives disclosed herein.

FIG. 11 is a plot showing the discharge capacity cycling of half coin cells having NCM622 cathode using conductive additive disclosed herein.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention generally relates to the manufacture of electrodes for electrochemical cells, in many cases for batteries such as, for instance, LIBs. In one example, the batteries of interest are rechargeable LIBs.

Typically, LIB batteries are named according to the acronyms for the electroactive material employed to form the cathode, often an intercalation compound. Embodiments described herein can be practiced with or adapted to various types of lithium-ion batteries currently known in the art (such as LCO, LMO, NCM, NCA, LCP, LFP, LFMP, LFSF or LTS, to name a few) or LIBs developed in the future.

Many electrode manufacturing techniques for electrochemical cell applications include the formation of an electrode (anode or cathode) composition that can be applied (coated, extruded, laminated, etc.) onto a conductive substrate. In the composition, the active electrode material is mixed (blended) with a binder (e.g., polymers, resins, etc.), which serves to associate and hold together the active materials. Liquids used to dissolve or carry the binder material, plasticizers and/or other additives often are included.

Generally, in a conventional solvent-based process, the polymer binder and other components are mixed with a suitable liquid to form a slurry that can then be applied onto the substrate. Typical liquid amounts employed are at least about 40% based on the total weight of the ingredients used; many wet processes require even higher solvent amounts. As the solvent is removed (e.g., during drying), the binder becomes increasingly sticky and adheres to the particles present and/or the substrate.

In contrast to slurry-based techniques, embodiments described herein involve a “solvent-free” also referred to as a “dry” process. In this solvent-free approach, some and typically all constituents (e.g., active material, binder, additives, etc.) needed to prepare the electrode composition are provided as loose particulate materials, e.g., free flowing powders, flakes, pellets, beads, and so forth. Implementations described herein can include one or more operations designed to mix these constituents (using, for instance, equipment designed to blend loose particulate materials) as well as at least one operation designed to process the binder. Subjecting the binder to certain shear conditions, for example, can result in binder deformations, e.g., binder elongations, formation of binder strands, entanglements, and so forth. With some types of binders, this is referred to as binder “fibrillization”.

In many aspects of the invention, ingredients are combined, and the binder is processed, e.g., fibrillized, without adding any liquid, e.g., solvent.

While most embodiments involve a process that is conducted without liquid addition and is completely solvent free, small amounts of liquid, e.g., solvent, can be used in some cases, to moisten, for instance, at least some of the particles being mixed. This may occur, for instance, when forming a pre-blend that is then completely dried prior to conducting subsequent operations. In one implementation, any solvent used to form such as pre-blend is removed, e.g., by drying, for instance, before the binder is deformed. Processing (e.g., fibrillizing) the binder is then conducted with loose, free flowing or pourable particles, under entirely solvent-free conditions.

Suitable solvents can be selected from solvents typically encountered in LIB production and include but are not limited to N-methylpyrrolidone (NMP), acetone, alcohols, and water. The solvent can be removed by standard drying techniques. It is expected that such low solvent levels can be removed completely or nearly so.

For many applications, the amount of solvent employed is no greater than about and often less than 1 weight % of the entire product electrode composition (a composition containing electroactive material, processed, e.g., fibrillized, binder and other ingredients, an additive component, for instance). In illustrative examples, the amount of solvent employed is within a range of from about 0 to at most 1 wt %, such as from about 0 to about 0.2, to about 0.4, to about 0.6, to about 0.8 wt %; or from about 0.2, to about 0.4, to about 0.6, to about 0.8, to about 1 wt %; or from about 0.2 to about 0.4, to about 0.6, to about 0.8, to about 1 wt %; or from about 0.4 to about 0.6, to about 0.8, to about 1 wt %; or from about 0.6 to about 0.8, to about 1.0 wt %; or from about 0.8 to about 1 wt %, based on the total weight of ingredients being used.

In other situations, solvent can be added in amounts within a range of from about 0 to about 10 wt %, such as within a range of form about 0 to about 2, to about 4, to about 6 to about 8 wt %; or from about 2 to about 4, to about 6, to about 8, to about 10 wt %; or from about 4 to about 6, to about 8 to about 10 wt %; or from about 6 to about 8, to about 10 wt %; or from about 8 to about 10 wt %.

While ingredients can be mixed and the binder processed, e.g., fibrillized, entirely in the absence of solvent, some electrode production schemes employ a small amount of solvent, in a post operation (an operation that takes place after the dry electrode composition has been formed), to “wet” a product film during calendering, for instance. Such a process also is referred to herein as a “dry” process.

Finished products, e.g., electrodes, free standing films or films laminated on the current collector, prepared by the solvent-free or dry process described herein, can be recognized by the absence of detectable processing solvents or processing solvent residues. In contrast, a product obtained by wet (slurry) techniques will typically contain detectable processing solvents and/or processing solvent residues. In a different approach, electrode products or films prepared according to embodiments of the invention are expected to display a uniform or substantially uniform binder distribution across the electrode or film thickness; in general, less uniformity is observed with wet techniques, which often lead to binder migrations towards a film surface.

As for the constituents employed, the solvent-free process described herein involves: an electroactive component (a material or combination of materials that participates in the electrochemical charge/discharge reactions of an electrochemical cell such as by absorbing or desorbing lithium); a binder, which can be a fibrillizable binder or a non-fibrillizable binder; and a multifunctional carbon black (CB). Additional ingredients can be included in some case.

For many LIB anodes, the electroactive material (also referred to herein as “active electrode material” or simply as “active material” or “AM”) is graphite, e.g., natural graphite, artificial graphite (e.g., massive artificial graphite (MAG)) or blends of both. Mesocarbon microbead (MCMB), mesophase-pitch-based carbon fiber (MCF), vapor grown carbon fiber (VGCF) also can be employed. In other implementations, the active anode compound comprises, consists essentially of or consists of silicon, such as, for instance, silicon-graphite composites, graphite containing nanosilicon (Si) or SiOₓ particles.

Principles described herein also can be used with other active anode materials such as, for instance, those known or currently explored, or those to be developed in the future. Examples include but are not limited to: (a) intercalation/de-intercalation materials (e.g., carbon based materials, porous carbon, graphene, TiO₂, Li₄Ti₅O₁₂, and so forth); (b) alloy/de-alloy materials (e.g., Si, SiOₓ, doped Si, Ge, Sn, Al, Bi, SnO₂, etc.); and (c) conversion materials (e.g., transition metal oxides (MnₓO_{y}, NiO, FeₓO_{y}, CuO, Cu₂O, MoO₂, etc.), metal sulfides, metal phosphides and metal nitrides represented by the formula MₓX_{y}, where X=S, P, N)).

The amount of the active anode material can vary, depending on the particular type of energy storage device. In illustrative examples, the amount of active anode material (graphite, for instance) is at least 80% by weight, e.g., at least 85, at least 90, at least 95, or at least 99 wt %, relative to the total weight of the (dry) electrode composition. The anode active material, e.g., graphite, can be provided in an amount of from about 80 to about: 85, 90, 93, 96, 99 wt %; or from about 85 to about: 90, 93, 96, 99 wt %; or from about 90 to about: 93, 96, 99 wt %; or from about 93 to about: 96, 99 wt %; or from about 96 to about 99 wt %.

The dry process for preparing LIBs cathodes can employ LCO (lithium cobalt oxide), LMO (lithium manganese oxide), NCM (lithium nickel cobalt manganese oxide), NCA (lithium nickel cobalt aluminum oxide), LCP (lithium cobalt phosphate), LFP (lithium iron phosphate), LMFP (Lithium Manganese Iron Phosphate), LFSF (lithium iron fluorosulfate), LTS (lithium titanium sulfide). Materials such as these are generally referred to herein as “lithium transition metal compounds”, e.g., “lithium transition metal oxides”. In addition to cathode materials based on intercalation chemistry, e.g., typically involving chemical reactions that transfer a single electron, other types of cathode materials (having lithium ions inserted into FeF₃, for instance) can transfer multiple electrons through more complex reaction mechanisms, called conversion reactions. Other active cathode materials known in the art or developed in the future can be used.

In some embodiments, the dry process described herein utilizes NCM (also referred to as “NMC”) or NCA cathode compositions. These materials are generally known to those skilled in the art. Moreover, many battery grade formulations in powder form (such as, for example, NCM 622) can be obtained commercially.

In more detail, NCM can be represented by the formula Li₁₊ₓ(Ni_{y}CO_{1-y-z}Mn_{z})₁₋ₓO₂, wherein x ranges from 0 to 1, y ranges from 0 to 1 (e.g., 0.3-0.8), and z ranges from 0 to 1 (e.g., 0.1-0.3). Examples of NCMs include Li₁₊ₓ(Ni_{0.33}Co_{0.33}Mn_{0.33})₁₋ₓO₂, Li₁₊ₓ(Ni_{0.4}Co_{0.3}Mn_{0.3})₁₋ₓO₂, Li₁₊ₓ(Ni_{0.4}Co_{0.2}Mn_{0.4})₁₋ₓO₂, Li₁₊ₓ(Ni_{0.4}Co_{0.1}Mn_{0.5})₁₋ₓO₂, Li₁₊ₓ(Ni_{0.5}Co_{0.1}Mn_{0.4})₁₋ₓO₂, Li₁₊ₓ(Ni_{0.5}Co_{0.3}Mn_{0.2})₁₋ₓO₂, Li₁₊ₓ(Ni_{0.5}Co_{0.2}Mn_{0.3})₁₋ₓO₂, Li₁₊ₓ(Ni_{0.6}Co_{0.2}Mn_{0.2})₁₋ₓO₂, Li₁₊ₓ(Ni_{0.8}Co_{0.1}Mn_{0.1})₁₋ₓO₂ and Li1+x(Ni0.9C0.05Mn0.05) 1-xO2.

NCA can be represented by the formula Li₁₊ₓ(Ni_{y}CO_{1-y-z}Al_{z})₁₋ₓO₂, wherein x ranges from 0 to 1, y ranges from 0 to 1, and z ranges from 0 to 1. An example of an NCA is Li₁₊ₓ(Ni_{0.8}Co_{0.15}Al_{0.05})₁₋ₓO₂.

The amount of electroactive cathode material employed can vary, depending on the particular type of energy storage device. In illustrative examples, the amount of NCM or NCA is at least 90% by weight, e.g., at least 93%, at least 96, at least 98, or at least 99% by weight, relative to the total weight of the (dry) electrode composition. NCM or NCA can be provided in an amount of from about 90 to about: 93, 96, 99 wt %; or from about 93 to about: 96, 99 wt %; or from about 96 to about 99 wt %.

In addition to the active material, the dry process described herein employs a binder. In general, the binder can be any semi-crystalline polymer.

In some embodiments, the binder is a fibrillizable binder. The fibrillizable binder can be provided in a binder component that consists of, consists essentially of, or comprises the fibrillizable binder.

Under certain processing conditions, e.g., high shear mixing in the presence of a fibrillizing agent, a fibrillizable binder is capable of producing fibrils, forming a network that can connect and support other particles present in the formulation. In more detail, it is believed that fibrillization of the binder generates a matrix, lattice, or web of fibrils that imparts mechanical structure to the electrode. In a product electrode, a fibrillized binder can be detected in SEM images which will show the presence of fibrils wrapped around at least a portion of at least some of the particles present, e.g., active material particles. Other indirect techniques that can be employed to evaluate relative degree of binder fibrillization include, for instance, energy-dispersive X-ray spectroscopy (EDX), powder rheology, tensile strength. EDX allows to map fluorine element distribution throughout the dry electrode and evaluate effectiveness of binder fibrillization. Powder rheology measures the cohesive interaction between the particles in the free-flowing electrode powder mix, while tensile strength testing measures strength of the free-standing electrode film, both being representative of the degree of binder fibrillization. In some cases, poor or no fibrillization can be inferred for dry product electrode films that crumble or peel away from the substrate.

In some implementations the fibrillizable binder is a fibrillizable fluoropolymer, such as, for instance, polytetrafluoroethylene or PTFE. Other binders that can be considered fibrillizable include but are not limited to ultra-high molecular weight polypropylene, polyethylene, and co-polymers and any combination thereof.

The fibrillizable binder (alone or as a constituent in a binder component (e.g., in a polymer blend)) can be provided in an amount of about 1 to about 10% by weight, e.g., about 1-2, 2-3, 3-4, 4-5, 5-6, 6-7, 7-8, 8-9, 9-10 wt %. In one example, the fibrillizable binder is provided in an amount of about 5 wt %. In other examples the fibrillizable binder is provided in an amount within a range of from about 1 to: about 2, about 3, about 4, about 5, about 6, about 7, about 8, about 9 wt %; or from about 2 to: about 3, about 4, about 5, about 6, about 7, about 8, about 9, about 10 wt %; or from about 3 to: about 4, about 5, about 6, about 7, about 8, about 9, about 10 wt %; or from about 4 to: about 5, about 6, about 7, about 8, about 9, about 10 wt %; or from about 5 to: about 6, about 7, about 8, about 9, about 10; or from about 6 to: about 7, about 8, about 9, about 10 wt %; or from about 7 to: about 8, about 9, about 10 wt %; or from about 8 to: about 9, about 10 wt %.

Not all situations, however, will employ a binder that is fibrillizable. Thus, some embodiments of the invention employ a binder component that consists of, consists essentially of, or comprises one or more non-fibrillizable binders. As used herein, the term “non-fibrillizable” binder refers to a binder that is difficult to fibrillize at the same conditions that are sufficient to fibrillate a “fibrillizable” binder. Nevertheless, even without reaching full fibrillization, practicing aspects of the invention (at the same or substantially the same processing conditions used for a fibrillizable counterpart) can still deform, e.g., stretch out, elongate, entangle, etc. a non-fibrillizable binder, often to a significant extent.

Without wishing to be bound by a particular interpretation or mechanism, it is believed that fibrillization may be thought of as an extreme phenomenon, where the binder polymer (which may start out as a colloidal particle) becomes stretched out very thinly, forming very long (high aspect ratio) strands (ribbons) that can bridge across more than two electroactive particles, thereby holding them together. Practicing embodiments described herein also can lead to stretching (elongating) and/or entangling a non fibrillizable binder, forming CB-binder composites and/or becoming coated with CB. Even if not fully fibrillated, such a “processed” non-fibrillizable binder can still serve as a glue, connecting, binding together and providing connectivity for the electroactive particles and adhesion to the current collector. Deformations of a non-fibrillizable binder can be observed by at least some of the techniques noted above.

In one example, the non-fibrillizable binder is a fluoropolymer such as polyvinylidene fluoride (PVDF). Other examples of binders that can be considered non-fibrillizable include poly (vinyldifluoroethylene-co-hexafluoropropylene) (PVDF-HFP), polyimides, and water-soluble binders, such as poly(ethylene) oxide, polyvinyl-alcohol (PVA), polyvinyl pyrrolidone (PVP), polyvinyl acetate, polyethylene-co-vinyl acetate, some polyolefins, cellulose, cellulose derivatives, to name a few. Other possible non-fibrillizable binders include polyethylene and polypropylene other than ultra-high molecular weight, ethylene-propylene-diene terpolymer (EPDM), sulfonated EPDM, styrene-butadiene rubber (SBR), and fluoro rubber, and copolymers and mixtures thereof. In one example, the non-fibrillizable binder is a cellulose ester, a cellulose ether, cellulose nitrate, a carboxyalkylcellulose, a cellulose salt and a cellulose salt derivative. In some embodiments, the microparticulate non-fibrillizable binder is selected from at least one of cellulose, cellulose acetate, methylcellulose, ethylcellulose, hydroxylpropylcellulose (HPC), hydroxyethylcellulose (HEC), cellulose nitrate, carboxymethylcellulose (CMC), carboxyethylcellulose, carboxypropylcellulose, carboxyisopropylcellulose, sodium cellulose, sodium cellulose nitrate, and sodium carboxyalkylcellulose. Other examples employ combinations of a non-fibrillizable binder, PVDF, for instance, and non-fibrillizable binder, PTFE, for instance.

Amounts of non-fibrillizable binders that can be used are the same or similar to those used for fibrillizable binders. Other suitable amounts can be determined by routine experimentation, for example.

Fibrillizable binders in combination with non-fibrillizable binders also can be employed.

Electrode compositions routinely include ingredients such as conductive additives (e.g., conductive carbon additives or CCA), plasticizers and so forth. In the case of solvent-free processes, common techniques also call for a binder fibrillizing (also known as “fibrillating”) agent or aid, typically AC.

It was discovered that conventional fibrillizing additives (AC, for example) can be supplemented and often entirely replaced by a CB material that provides multiple benefits. Certain carbon blacks, for example, can serve as binder fibrillating (or, in some cases, binder deforming) agents, as conductive additives (generating conductive networks, e.g., the long-range conductivity of the electrode), and as mechanical strengthening aids (imparting mechanical support, stability and/or flexibility to the electrode product, often the coating, layer or film typically applied onto the conductive substrate to form a battery electrode).

Generally, CBs are materials that exist in the form of aggregates, which, in turn, are formed of CB primary particles. In most cases, primary particles do not exist independently of the CB aggregate. While the primary particles can have a mean primary particle diameter within the range of from about 10 nanometers (nm) to about 50 nm, e.g., from about 10 nm to about 15 nm; from about 10 nm to about 20 nm; from about 10 nm to about 25 nm; from about 10 nm to about 30 nm; or from about 10 nm to about 40 nm, the aggregates can be considerably larger. CB aggregates have fractal geometries and are often referred in the art as CB “particles” (not to be confused with the “primary particles” discussed above).

Many types of CB are produced in a furnace-type reactor by pyrolyzing a hydrocarbon feedstock (FS) with hot combustion gases to produce combustion products containing particulate CB. Characteristics of a given CB often depend upon the conditions of manufacture and may be altered or modified, e.g., by changes in temperature, pressure, FS, residence time, quench temperature, throughput, and/or other parameters.

As known in the art, CBs can be described by certain properties determined according to procedures, often standardized protocols, well known in the art. For instance, CBs can be characterized by their Brunauer-Emmett-Teller (BET) surface area, measured, for example, according to ASTM D6556-10; by their oil adsorption number (OAN), determined, for instance, according to ASTM D 2414-16; by their statistical thickness surface areas (STSAs), a property that can be determined by ASTM D 6556-10.

For a given CB, it may also be of interest, in some cases, to specify the ratio of its STSA to its BET surface area (STSA: BET ratio).

Crystalline domains of CBs can be characterized by an La crystallite size, as determined by Raman spectroscopy. La is defined as 43.5× (area of G band/area of D band). The crystallite size can give an indication of the degree of graphitization, where a higher La value correlates with a higher degree of graphitization. Raman measurements of La were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands at about 1340 cm-1 and 1580 cm-1, denoted as the “D” and “G” bands, respectively. It is generally considered that the D band is attributed to disordered sp² carbon, and the G band to graphitic or “ordered” sp² carbon. Using an empirical approach, the ratio of the G/D bands and an La measured by X-ray diffraction (XRD) are highly correlated, and regression analysis gives the empirical relationship:

$${L}_{a} = 43.5 \times ( area of G band / area of D band ) ,$$

in which Lₐ is calculated in Angstroms. Thus, a higher Lₐ value corresponds to a more ordered crystalline structure.

The crystalline domains can be characterized by a L_{c} crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (20) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: L_{c} (Å)=K*λ/(β*cosθ), where K is the shape factor constant (0.9); λ is the wavelength of the characteristic X-ray line of Cu K_{α1} (1.54056 Å); β is the peak width at half maximum in radians; and θ is determined by taking half of the measuring angle peak position (2θ).

Surface cleanliness can be described by the surface energy (SEP) of the CB, a property that can be determined by Dynamic Vapor (Water) Sorption (DVS) or water spreading pressure (described, for instance in U.S. Pat. No. 10,886,535 B2, issued on Jan. 5, 2021 to Korchev et al. and incorporated herein by this reference.

Mean pore diameters and pore volumes can be determined in accordance with the techniques described in E. P. Barrett, L. G. Joyner, P. P. Halenda, J. Am. Chem. Soc. 1951, 73, 373-380 (BJH method).

Other techniques that can be used to study CBs include Fourier transform infrared (FTIR) spectroscopy, thermogravimetric analysis (TGA), X-ray photoelectron spectroscopy (XPS), scanning electron microscopy (SEM), and transmission electron microscopy (TEM). FTIR spectroscopy is particularly useful for determining the nature of surface functional groups, while SEM/TEM techniques help to visualize the size and morphology of the particles. XPS is often used to determine the elemental composition of a material and TGA can provide information on the decomposition and oxidation characteristics of carbons.

Tables 1A and 1B below present physical properties characterizing illustrative CBs, namely CB1 through CB17.

TABLE 1A

| | | | | | La | | |
|---|---|---|---|---|---|---|---|
| | BET SA, | STSA, | OAN, | | Raman, | (IG/(IG + ID)) | Lc XRD, |
| Sample | m²/g | m²/g | mL/100 g | SEP mJ/m² | Å | % Cr Raman | Å |
| CB1 | 36 | 35 | 125 | NA | NA | NA | NA |
| CB2 | 59 | 59 | 220 | 4 | 26.1 | 37.5 | 19.7 |
| CB3 | 100 | 100 | 231 | 2.06 | 27.1 | 39.6 | 20.1 |
| CB4 | 131 | 97 | 230 | 28 | 13 | 23 | NA |
| CB5 | 134 | 136 | 311 | 3.3 | 43.5 | 44.2 | 22.4 |
| CB6 | 169 | 144 | 155 | 10.2 | 26.4 | 37.7 | 18.8 |
| CB7 | 541 | 254 | 225 | 25.9 | NA | NA | NA |
| CB8 | 717 | 182 | 249 | 15 | NA | NA | NA |
| CB9 | 855 | NA | 280 | 6.7 | 25.5 | 37 | N/A |
| CB10 | 1055 | 317 | 278 | 11 | 17.2 | 28.3 | N/A |
| CB11 | 1389 | 423 | 328 | 14.7 | 17 | 28.1 | N/A |
| CB12 | 1491 | 507 | NA | 12.5 | NA | NA | NA |
| CB13 | 1388 | 1330 | 490 | 6.7 | 22.8 | 34.4 | N/A |
| CB14 | 1420 | 585 | 330 | 13.4 | 17.7 | 28.7 | 13.5 |
| CB15 | 1430 | 1415 | 605 | 2.5 | 20.9 | 32.4 | 12.8 |
| CB16 | 1420 | 389 | 181 | 13 | NA | NA | 12.5 |
| CB17 | 60 | 60 | 230 | 10 | 19 | NA | NA |

TABLE 1B

| | Pore volume | Pore volume | Pore volume | |
|---|---|---|---|---|
| | (cm³/g) by | (cm³/g) by | (cm³/g) by | Total Pore |
| | BJH (pore | BJH (pore size | BJH (pore | Volume |
| Sample | size < 2 nm) | 2 nm-50 nm) | size > 50 nm) | (cm³/g) |
| CB1 | NA | NA | NA | NA |
| CB2 | NA | NA | NA | NA |
| CB3 | 0.003 | 0.15 | 0.21 | 0.36 |
| CB4 | NA | 0.1 | 0.15 | 0.26 |
| CB5 | NA | NA | NA | NA |
| CB6 | 0.004 | 0.21 | 0.36 | 0.57 |
| CB7 | 0.008 | 0.32 | 0.56 | 0.89 |
| CB8 | 0.005 | 0.25 | 0.35 | 0.61 |
| CB9 | 0.015 | 0.66 | 1.54 | 2.21 |
| CB10 | 0.013 | 0.43 | 1.2 | 1.6 |
| CB11 | 0.02 | 1.07 | 0.93 | 2.02 |
| CB12 | 0.028 | 0.49 | 0.64 | 1.15 |
| CB13 | 0.03 | 1.48 | 1.4 | 2.91 |
| CB14 | 0.024 | 0.85 | 1.61 | 2.48 |
| CB15 | NA | 1.47 | 0.4 | 2.22 |
| CB16 | 0.01 | 0.94 | 0.17 | 1.12 |
| CB17 | NA | NA | NA | NA |

Various CBs have been and continue to be developed for carbon conductive additive (CCA) applications. Attractive electroconductivity often combines a high specific surface and extensively developed structure (the arrangement of primary CB particles within an aggregate) and porosity. CBs that can be added to anode and/or cathodes compositions for LIBs prepared by a slurry process are described, for instance, in International Publication Nos. WO 2020/197670, to Cabot Corp., published on Oct. 1, 2020, and WO 2020/197673, to Cabot Corp., published on Oct. 1, 2020. Both are incorporated herein by this reference in their entirety.

Examples of commercially available CBs that can be effective CCAs include LITX® 50, LITX® 63, LITX® 66, LITX® 200, LITX® 300, LITX® HP and LITX® MAX 90 carbon black particles available from Cabot Corporation; C-NERGY™ C45, C-NERGY™ C65 and SUPER PR products from Imerys; Li-400, Li-250, Li-100 and Li-435 products from Denka; and the EC300 and EC600 product from Ketjen.

Further to displaying the electroconductivity desired for LIB applications, other properties that may contribute to the multifunctionality of a CB involve one, more or all of the following: surface roughness; surface chemistry (surface energy); particle strength; and particle size.

Typically, the CB surface roughness is related to the porosity of the particles, described, for instance, by a pore volume or pore size distribution. RMS surface roughness (calculated as the Root Mean Square of a surface's measured microscopic peaks and valleys), for example, is known to correlate with surface pore size (e.g., similar order of magnitude). For instance, 2 nm pores can be indicative of an approximate RMS surface roughness of 1 nm.

Broadly, CB porosity can fall into one or more of the following categories: microporosity, defined by pores having diameter less than 2 nm; mesoporosity, defined by pores of a diameter ranging from 2 to 50 nm; and macroporosity, defined by pores having a diameter larger than 50 nm.

Pore size distribution and pore volume in carbon black can be determined by gas physisorption techniques such as nitrogen adsorption porosimetry by measuring nitrogen gas adsorption using BET analysis followed by fitting the adsorption isotherms with different models, for example, the DFT (density function theory) and the BJH (Barrett-Joyner-Halenda) model, depending on the pore size region of interest. The BJH adsorption model was relied upon to fit the N2 adsorption isotherm and calculate the mesopore and macropore volumes presented herein.

Without wishing to be bound by a particular interpretation, it is believed that fibrillizing properties in multifunctional CBs may be driven, at least in part, by the macroporosity of the particle, with macropores acting as anchoring points for interlocking the binder on the CB surface and stretching the binder into fibrils when high shear forces are applied.

While some carbon blacks are predominantly microporous materials, techniques exist for increasing porosity levels and/or producing CBs with tailored porosity types.

Contacting a CB starting material with an oxidant stream, for instance, can enhance porosity, in particular the mesoporous character of the CB product. Increasing the porosity of furnace blacks can be achieved by lengthening the residence time in the carbon black reactor, allowing the tail gas additional time to attack and etch the carbon surface. Another method relies on the addition of alkali earth metal ions to the carbon black feedstock, as these ions are known to catalyze the etching of the carbon black via the tail gas. Both techniques involve etching the CB “in-situ,” i.e., in the furnace reactor during production, in order to create carbon blacks with internal porosity. Some approaches that can be employed to modify carbon blacks are described, for instance, in U.S. Pat. No. 8,895,142 B2, to Kyrlidis et al. and 10,087,330 B2, to Green et al., both being incorporated herein by this reference. Commercially, modified carbon blacks that can be utilized are available from Cabot Corporation. In Tables 1A and 1B above, CB 15 is the steam-etched version of CB4.

Fibrillizing properties also were found to depend on the surface chemistry or surface activity, a function that is often related to the manufacturing and/or heating process employed in preparing a particular CB. In many cases, surface chemistry or surface activity is associated with oxygen-containing groups found on the CB surface. In some embodiments, good fibrillating CB candidates lack or are depleted in oxygen-containing surface groups, tending to be less hydrophilic (more hydrophobic).

For example, it is believed that effective fibrillization is driven, at least in part, by the affinity (adhesion) of CB to the binder, e.g., a fibrillizable binder. Thus, in one implementation, the preferred multifunctional CBs for successfully fibrillizing a binder such as PTFE are hydrophobic CBs (namely CBs that lacking oxygen-containing surface groups) and/or low surface energy CBs. Oxygen content can be measured by inert gas fusion. Low surface chemistry CBs have oxygen content within a range of from about 10 ppm to about 5000 ppm, e.g., from about 100 ppm to about 1000 ppm.

The presence of oxygen-containing surface groups can be reduced or minimized by techniques such as heat treatment, or other surface modification approaches, as known in the art or as developed in the future. Surface-modified, e.g., heat-treated CBs, can be compared to and distinguished from regular carbon blacks by X-ray scattering, Raman spectroscopy, surface energy measurements by gas adsorption, or other techniques, as known in the art. In some cases, heat-treated and other surface-modified CBs also tend to display a reduced moisture uptake during processing. In Tables 1A and 1B, CB9 is a heat-treated version of CB11, while CB3 is a heat-treated version of CB4.

Other CB properties to be considered in multifunctional CB candidates relate to their physical form. The CB particle size, for example, is a property that can be determined by particle size distribution (PSD) techniques and/or scanning electrode microscopy (SEM). Also believed to play a role in the multifunctional character of the selected CB relates to the CB particle strength (displayed as particle hardness and/or particle cohesion). Particle strength allows the CB to effectively stretch the polymer binder; this along with particle roughness may represent very important mechanical properties to achieve desirable binder fibrilization. Particle strength can be measured by individual pellet crash test, oscillatory viscoelastic measurements, or other techniques, as known in the art.

Initially (before the CB has been subjected to mixing (in particular high shear mixing)), the D50 particle size of the multifunctional CB utilized can be within a range of from about 0.5 to about 20 μm, for example, within the range of from about 1 to about 10, e.g., from about 2 to about 5 μm. As a result of binder processing, e.g., fibrillization (typically under high shear conditions), the starting multifunctional CB particles can break into smaller particles having, for example, a particle size within a range of from about 0.05 to about 1 μm, e.g., from about 0.1 to about 0.3 μm.

A multifunctional CB can be combined with a second CB (which may or may not be multifunctional), in a CB blend, for example.

The CB particulate material can be provided in any number of forms. Truly fluffy CB-containing powders, for example, have been found to perform particularly well in some of the dry processes tested. Such powdery materials can be characterized by their particle size, BET, and/or other properties. In many cases, powders employed have a density no greater than about 100 g/cm³.

Less fluffy CB particles, in the form of jet-milled pellets, for instance, also can be utilized. Powder CBs can be pelletized using techniques and equipment known in the art. In one example, CB is pelletized with an emulsion solution of the binder utilized to form the electrode composition described herein. Other approaches employ an emulsion solution of a different binder, for instance, a binder that belongs to the same chemical family or has similar functionally active groups that can bind or otherwise interact with the binder employed to carry out the dry process. It is thought that, as a result, the energetics interaction of the pelletized CB with the binder used to prepare the electrode composition increases.

Pellet size, which applies to pure CB, can be within a range of from about 0.1 mm to about 5 mm. In one example, to pellet size is from about 0.1 to about: 0.5, 1, 1.5, 2, 2.5, 3, 3.5, 4, 4.5 mm: or from about 0.5 to about: 1, 1.5, 2, 2.5, 3, 3.5, 4, 4.5, 5 mm; or from about 1 to about: 1.5, 2, 2.5, 3, 3.5, 4, 4.5, 5 mm; or from about 1.5 to about: 2, 2.5, 3, 3.5, 4, 4.5, 5 mm; or from about 2 to about: 2.5, 3, 3.5, 4, 4.5, 5 mm; or from about 2.5 to about: 3, 3.5, 4, 4.5, 5 mm; or from about 3 to about 3.5, 4, 4.5, 5 mm; or from about 3.5 to about: 4, 4.5, 5 mm; or from about 4 to about: 4.5, 5 mm; or from about 4.5 to about 5 mm.

Granules of carbon black also may be useful in some situations. In many cases, CB granules are a densified form of CB, without polymer being present in the final product. Generally, CB granules can be formed via a conventional pelletization process associated with CB production. It is also possible to form CB granules by dispersing fluffy CB in water, followed by spray drying.

In some embodiments, the granules employed change their form and/or function during the solvent-free techniques described herein. Thus, an initial CB granular material can be relied upon to process, e.g., fibrillate, a polymer binder. Size comminution occurring during this operation can release smaller CB units. In the presence of an electroactive material, the fragmentation of the granules may enhance the distribution of the smaller CB units throughout the electrode composition, resulting in electrode films with improved electrical conductivity and/or mechanical strength.

The surface roughness and/or surface energy of the granules often is controlled by choosing the particles composing the granules. For instance, the surface roughness can be selected based on the surface texture created by the primary particles and/or aggregates that compose the secondary granule. Such a surface is rough on a dimensional scale where roughness is provided by nano/micro scale of hills and valleys on the surface of the CB granule.

A multifunctional CB in granular shape can have a particle size in the micron range, e.g., 1-10 μm, such as, for instance: from about 1 to about: 2, 3, 4, 5, 6, 7, 8, 9 μm; or from about 2 to about: 3, 4, 5, 6, 7, 8, 9, 10 μm; or from about 3 to about: 4, 5, 6, 7, 8, 9, 10 μm; or from about 4 to about: 5, 6, 7, 8, 9, 10 μm; or from about 5 to about 6, 7, 8, 9, 10 μm; or from about 6 to about: 7, 8, 9, 10 μm; or from about 7 to about: 8, 9, 10 μm; or from about 8 to about: 9, 10 μm; or from about 9 to about 10 μm. With some granules, an initial size can be reduced by grinding to various degrees, for example from roughly 10 microns down to below 1 micron. Some implementations utilize a combination of sizes.

The strength of the granules also can be considered. It can be minimized by forming the granule in the absence (or with minimal content) of binder during granule formation; increased strength of the granules can be achieved by using varying concentrations of binders and/or different types of binders. In some implementations, the binder employed to form the CB granules is the same or a similar binder to the binder employed in the dry process, e.g., a fibrillizable binder.

Some embodiments employ granules that are friable, under processing, e.g., fibrillization conditions. In such cases, the strength of the granules can be controlled so that the strength is high enough to fibrillate or deform the polymer binder and low enough for the granules to fall apart and release conducting and reinforcing carbon units, such as aggregates.

The granular CB can be used as a multifunctional additive alone or in combination with another form of CB, which too can be multifunctional, in some cases.

The CB employed in the dry processes described herein is selected or tailored to perform two or more functions. In specific embodiments, various CB attributes are balanced to achieve as good a combination of electrical conductivity, binder fibrillization and/or mechanical characteristics as possible. A CB considered to be an excellent CCA additive, for example, may not necessarily turn out to be a good or even an adequate fibrillating aid. Thus, a selection process and at times a compromise may be needed in using a CB that brings about good electrical conductivity together with good fibrillization attributes. Achieving or optimizing the multifunctional character of a CB can rely on experimental evaluations that test performance of films and/or electrodes produced by a solvent-free process. Suitable CBs also can be selected by considering their properties, e.g., in relation to a specific dry process protocol or conditions.

In one illustration, the CB is selected to combine sufficient surface area (measured by BET N₂ adsorption, for example) for best binder processing, e.g., fibrillization, while ensuring that the particular CB agglomerates employed (e.g., CB pellets or jet mill CB particles) can break down into particles small enough, e.g., less than 2 microns (μm), to maximize surface interactions between CB particle and the binder and thus effectively process, e.g., fibrillize, the binder.

The CB employed in the dry process described herein can have a BET that is no greater than about 1600 m²/g, e.g., no greater than about: 1500, 1400, 1300, 1200, 1100, 1000, 900, 800, 700, 600, 500, 400, 300, 200, 100 or 35 m²/g. The BET can be within a range of from about 35 to about 1600, such as, for example, within a range of from about 35 to about: 100, 200, 300, 400, 500, 600, 700, 800, 900, 1000, 1100, 1200, 1300, 1400, 1500; or from about 100 to about: 200, 300, 400, 500, 600, 700, 800, 900, 1000, 1100, 1200, 1300, 1400, 1500, 1600; or from about 200 to about: 300, 400, 500, 600, 700, 800, 900, 1000, 1100, 1200, 1300, 1400, 1500, 1600; or from about 300 to about: 400, 500, 600, 700, 800, 900, 1000, 1100, 1200, 1300, 1400, 1500, 1600; or from about 400 to about: 500, 600, 700, 800, 900, 1000, 1100, 1200, 1300, 1400, 1500, 1600; or from about 500 to about: 600, 700, 800, 900, 1000, 1100, 1200, 1300, 1400, 1500, 1600; or from about 600 to about: 700, 800, 900, 1000, 1100, 1200, 1300, 1400, 1500, 1600; or from about 700 to about 800, 900, 1000, 1100, 1200, 1300, 1400, 1500, 1600; or from about 800 to about: 900, 1000, 1100, 1200, 1300, 1400, 1500, 1600; or from about 900 to about: 1000, 1100, 1200, 1300, 1400, 1500, 1600; or from about 1000 to about: 1100, 1200, 1300, 1400, 1500, 1600; or from about 1100 to about: 1200, 1300, 1400, 1500, 1600; or from about 1200 to about: 1300, 1400, 1500, 1600; or from about 1300 to about 1400, 1500, 1600; or from about 1400 to about: 1500 m²/g, 1600; or from about 1500 to about 1600.

The CB employed in the dry process described herein can have an OAN that is no greater than about 650 ml/100 g, e.g., no greater than about 600, no greater than about 500, no greater than about 400, no greater than about 300, no greater than about 250, no greater than about 200, no greater than about 150, no greater than about 120 ml/100 g. The multifunctional CB can have an OAN within the range of from about 120 to about 650 ml/100 g, e.g., from about 120 to about 200, to about 300, to about 400, to about 500, to about 600, to about 650 ml/100 g; or from about 200 to about 300, to about 400, to about 500, to about 600, to about 650 ml/100 g; or from about 300 to about 400, to about 500, to about 600, to about 650 ml/100 g; or from about 400 to about 500, or to about 600, to about 650 ml/100 g; or from about 500 to about 600, to about 650 ml/100 g; or from about 600 to about 650 ml/100 g.

LIB anodes can be prepared by a dry process that utilizes a CB having a BET that is no greater than about 1600 m²/g, such as no greater than about 1500, no greater than about 1200, no greater than about 1000, no greater than about 700, no greater than about 500, no greater than about 200, no greater than about 100, or no greater than about 35 m²/g. The BET can be within a range of from about 35 to about 1600 m²/g. For instance, the BET can be within a range of from about 35 to about 50, to about 75, to about 100, to about 150, to about 200; or from about 50 to about 75, to about 100, to about 150, to about 200; or from about 75 to about 100, to about 150, to about 200; or from about 100 to about 150, to about 200; or from about 150 to about 200 m²/g. In one example, the selected CB has a BET within a range of from about 55 to about 200 m²/g.

For anode applications, the CB used in the solvent-free method described herein can have an OAN that is no greater than about 650 ml/100 g, e.g., no greater than about 500, no greater than about 400, no greater than about 300, no greater than about 240, no greater than about 200, no greater than about 150, no greater than about 120 ml/100 g. In one implementation, the CB selected for preparing an LIB anode by a dry process has an OAN within a range of from about 120 to about 650 ml/100 g such as within a range of from about 120 to about 150, to about 200, to about 240, to about 300 ml/100 g; or from about 120 to about 150, to about 200, to about 240, to about 300 ml/100 g; or from about 120 to about 150, to about 200, to about 240, to about 300 ml/100 g; or from about 150 to about 200, to about 240, to about 300 ml/100 g; or from about 200 to about 240, to about 300 ml/100 g; or from about 240 to about 300 ml/100 g. In one example, the selected CB has an OAN within a range of from about 130 to about 240 ml/100 g.

LIB cathodes can be prepared by a dry process that utilizes a CB having a BET that is at least about 90 m²/g, such as at least about at least: 90, 100, 200, 300, 400, 500, 600, 700, 800, 900, 1000, 1100, 1200, 1300, 1400, 1500, up to about 1600 m²/g. The BET can be within a range of from about 500 to about 1600 m²/g, such as within a range of from about 800 to about: 900, 1000, 1100, 1200, 1300, 1400, 1500; or from about 900 to about: 1000, 1100, 1200, 1300, 1400, 1500, 1600; or from about 1000 to about 1100, 1200, 1300, 1400, 1500, 1600; or from about 1100 to about: 1200, 1300, 1400, 1500, 1600; or from about 1200 to about 1300, 1400, 1500, 1600; or from about 1300 to about: 1400, 1500, 1600; or from about 1400 to about 1500, 1600 m²/g, or from about 1500 to about 1600 m²/g. In one example, the selected CB has a BET within a range of from about 1350 to about 1600 m²/g. In another example, the selected CB has a BET within a range of from about 50 to about 190, such as within a range of from about 90 to about 100 m²/g. In a further example, the CB has a BET between 500 and 650 m²/g.

For cathode applications, the CB used in the solvent-free method described herein can have an OAN no greater than about 650 ml/100 g, e.g., less than about 600, less than about 500, less than about 500, less than about 400, less than about 300, less than about 250, less than about 200, down to about 120 ml/100 g. The CB can have an OAN within the range of from about 120 to about 250, to about 350, to about 450, to about 550; or from about 250 to about 350, to about 450, to about 550, to about 650; or from about 350, to about 450, to about 550, to about 650; or from about 450 to about 550, to about 650 ml/100 g; or from about 550 to about 650 ml/100 g. In one example, the selected CB has an OAN within a range of from about 250 to about 650 ml/100 g.

In many cases, CBs that can be used to prepare LIB cathodes by the dry process described herein have a BET within a range of from about 80 to about 1600 m²/g and an OAN within a range of from about 120 to about 650 ml/100 g. An illustrative CB that can be used to prepare a LIB cathode has a relatively high BET surface area (e.g., within a range of from about 1350 to about 1600 m²/g), coupled with a relatively low OAN (e.g., within a range of from about 120 to about 220 ml/100 g). Another illustrative CB that can be used to prepare a LIB cathode has a BET surface area within a range of from about 80 to about 200 m²/g and an OAN within a range of from about 140 to about 280 m²/g, such as about 240 or lower, within a range of from about 140 to about 180 ml/100 g, for example. A further illustrative CB has a BET within a range of from about 500 to about 1600 m²/g and an OAN within a range of from about 180 to about 650 ml/100 g. Yet another illustrative CB that can be used to prepare a LIB cathode has a BET surface area below 650 m²/g (e.g., within a range of from about 500 to about 650 m²/g) and an OAN within a range of from about 180 to about 260 ml/100 g.

In many cases, CBs that can be used to prepare LIB anodes by the dry process described herein have a BET within a range of from about 35 to about 1600 m²/g and an OAN within a range of from about 120 to about 650 ml/100 g. An illustrative CB that can be used to prepare a LIB anode has a relatively low BET surface area (e.g., within a range of from about 50 to about 200 m²/g) coupled with an OAN within a range of from about 130 to about 240 ml/100 g.

In many implementations, the multifunctional CB has an Lₐ crystallite size of at least 17 Å, for example, from 17 Å to 50 Å. For instance, the CB can have an Lₐ crystallite size of from about 17 Å to: about 20, about 30, about 40 Å; or from about 20 Å to about 30, to about 40, to about 50 Å; or from about 30 Å to: about 40, about 50 Å; or from about 40 to about 50 Å.

The multifunctional CB described herein can have a surface energy (SEP) of less than or equal to 15 mJ/m², for example, from about 1 to about 10 mJ/m², such as from about 1 to: about 3, about 5, about 7, about 9 mJ/m²; or from about 3 to: about 5, about 7, about 9, about 10 mJ/m²; or from about 5 to: about 7, about 9, about 10 mJ/m²; or from about 7 to: about 9, about 10 mJ/m²; or from about 9 to about 10 mJ/m².

With respect to the porosity, the multifunctional CB can have a mesopore volume of at least 0.35 cm³/g, e.g., from about 0.35 to about 2 cm³/g, and a total mesopore and macropore volume of at least 1 cm³/g, e.g., from about 1 to about 3 cm³/g. In some implementations, for high surface area CBs (e.g., BET greater than about 800 m²/g), for example, the mesopore volume is from about 0.35 to: about 0.5, about 1, about 1.5; of from about 0.5 to: about 1, about 1.5 cm³/g, about 2; or from about 1 to: about 1.5, about 2; or from about 1.5 to about 2 cm³/g.

Total mesopore and macropore volumes characterizing multifunctional CBs can be at least 0.2 cm³/g, typically higher. In one example, the multifunctional CB used to prepare an anode composition has a total mesopore and macropore volume within a range of from about 0.2 to about 0.8 cm³/g. Multifunctional CBs suitable for preparing a cathode composition often have a total mesoporosity and macroporosity that is at least 1 cm³/g.

The total mesopore and macropore volume can be from about 1 to: about 1.5, about 2, about 2.5 cm³/g; or from about 1.5 to: about 2.0, about 2.5, about 3 cm³/g; or from about 2 to: about 2.5, about 3 cm³/g; or from about 2.5 to about 3 cm³/g.

In many implementations, the multifunctional CB has a % crystallinity of at least 22%, for example, from 23% to 50%, such as within a range of from about 23 to about: 30, 35, 40, 45%; or from about 30 to about: 35, 40, 45, 50%; or from about 35 to about: 40, 45, 50%; or from about 40 to about: 45, 50%; of from about 45 to about 50%.

Examples of suitable CB materials that can be utilized include commercially available specifications such as: Vulcan® series CB such as Vulcan® XCmax 22, a Black Pearl® series CB such as BP 2000 carbon black, PBX® series CB such as PBX 51, LITX® series CB such as LITX HP, from Cabot Corporation.

The electrode compositions prepared by a solvent-free process such as described herein will typically include a multifunctional CB (such as described herein), an active electrode material, and a “processed” binder. Some product electrode compositions, in particular those prepared with a fibrillizable binder, will include a post fibrillization binder (also referred to herein as a “fibrillized binder”), often exhibiting fibrils of high aspect ratios. Compositions prepared with non-fibrillizable binders will still present a “processed” binder, namely a binder that is “deformed” (elongated, entangled, etc.) but perhaps to a lesser extent than that observed with fibrillizable binders at the same or substantially the same fibrillization conditions. A processed, e.g., fibrillized, binder can be detected by techniques described above. Successful binder processing, e.g., fibrillization, often is reflected by the quality of the resulting product, an electrode film, for example. In some cases, electrode compositions prepared with non fibrillizable binders will include a binder that is “undeformed” (globular, rounded, spherical shaped, etc.). Even in such situations, a multifunctional CB may act as a binder and mechanical reinforcement of the electrode, while also imparting desirable electrical properties.

The electrode compositions can be employed to form an anode, cathode or both an anode and a cathode, e.g., for assembly in a device such as a LIB. One, more, or all properties characterizing multifunctional CBs can be assessed in the product electrode composition, (in which the binder has been processed, e.g., fibrillized), in product electrodes (e.g., films), typically obtained by further processing the product electrode composition, assembled electrodes (in which the product electrode, e.g., film, has been applied to the suitable substrate) and/or batteries described herein. For example, the electrode can be tested for adhesion (assessing the attachment of the electrode film to a substrate), cohesion (assessing how well particles are bound together), electrode resistivity and/or other properties, by techniques known in the art.

Based on the total weight of the electrode composition, the multifunctional CB can be provided in an amount within a range of from about 0.1 to about 10 wt %, e.g., from about 0.3 to about 5.0 wt %, e.g., from about 0.3 to about 3 wt %. Thus, in one implementation, the multifunctional CB is present in the composition in an amount within a range of from about 0.3 to: about 0.5, about 1.0, about 1.5, about 2.0, about 2.5; or from about 0.5 to: about 1.0, about 1.5, about 2.0, about 2.5, about 3; or from about 1.0 to: about 1.5, about 2.0, about 2.5, about 3.0; or from about 1.5 to: about 2.0, about 2.5, about 3.0; or from about 2.0 to: about 2.5, about 3.0; or from about 2.5 to about 3.0. Some implementations utilize CB amounts higher than about 3 wt %, such as, for example, between 3 and 5% by weight of the product electrode composition, e.g., between 3 and: 3.5, 4 or 4.5 wt %; between 3.5 and: 4, 4.5 or 5 wt %; between 4 and: 4.5 or 5 wt %; or between 4.5 and 5 wt %. Specific amounts within as well as outside these ranges can be selected.

In many cases, this amount is equal to or, preferably, lower than the AC amount required to obtain the same or substantially the same electrode performance. In an alternative approach, reaching a performance level established with AC is expected to require lower amounts of the multifunctional CB, freeing extra volume for electroactive material.

For an illustrative LIB graphite anode composition, the loading of the multifunctional CB is no greater than about 5 wt % and often no greater than about 3 wt %, for example no greater than 1 wt %. In specific examples, the loading of the multifunctional CB is within the rage of from about 0.1 wt % to about 1.0 wt %, such as, within the range of from about 0.1 to about 0.5, or from about 0.5 to about 1 wt %. Other examples employ higher loadings, e.g., within a range of from about 1 to about 5 wt %, such as a loading of at least about 4.5, 4.0, 3.5, 3.0, 2.5, 2.0 or 1.5.

For an illustrative NCM cathode composition, the loading of the multifunctional CB is no greater than about 5 wt % and often no greater than about 3 wt %, for example no greater than 1 wt %. In specific examples, the loading of the multifunctional CB is within the rage of from about 0.1 wt % to about 1.0 wt %, such as, within the range of from about 0.1 to about 0.5, or from about 0.5 to about 1 wt %. Other examples employ higher loadings, e.g., within the range of from about 1 to about 5 wt %, such as a loading of at least about 4.5, 4.0, 3.5, 3.0, 2.5, 2.0 or 1.5.

It has been discovered that, at least in some cases, a multifunctional CB that performs well when added to an anode composition will have different properties from the properties displayed by a multifunctional CB found to perform well in cathode compositions.

Thus, in some embodiments, graphite anodes are prepared using CBs that have a relatively clean surface (such as obtained by heat treatment, for example), relatively low surface area and structure and underdeveloped meso- and macro-porosity.

In other embodiments, NCM cathodes are prepared using CBs that have relatively high surface area and structure, developed meso- and macro-porosity (such as obtained by steam etching, for example).

Relative amounts of the CB multifunctional additive to the fibrillizable binder can be within a ratio of 5:1 to 0.1:10, e.g., from about 1:1 to 0.1:10, from 0.5:1 to 0.1:10; from 5:1 to 0.5:10, from 5:1 to 1:5; from 5:1 to 5:10 by weight. In specific cases, the weight ratio of CB multifunctional additive to fibrillizable binder is 1:1.

In one embodiment, the electrode composition contains active material in an amount of from about 90 wt % to about 99 wt %, e.g., to 98.0 wt %, fibrillizable binder in an amount of from about 1 wt % to about 5 wt % and a CB multifunctional additive in an amount of from about 0.3 wt % to about 5 wt %.

In many cases, the solvent-free process described herein is conducted in the absence of any fibrillating aids other than a CB multifunctional additive. In others, a multifunctional CB can be combined with another, e.g., a conventional, fibrillizing agent, such as AC.

As used herein, the term “fibrillizing aid” or “fibrillizing agent” refers to a material that is other than the binder or active electrode material and that promotes filbrillization of a fibrillizable binder. “Additional” or “other” fibrillizing aid or “additional” or “other” fibrillizing agent refers to a material other than (i.e., a material that excludes or is not) the multifunctional CB described above.

Further implementations utilize a multifunctional CB in combination with a substantially non-fibrillizing conductive additive, a conventional CCA, for instance. As used herein, the term “additional conductive additive” refers to a material other (i.e., a material that excludes or is not) a multifunctional CB such as described above. Typically, additional conductive additives lack or substantially lack fibrillization functionality.

Plasticizers and/or other materials conventionally used in electrode compositions can be included as well.

Some illustrative examples employ a multifunctional CB along with another (additional) material, e.g., a conventional fibrillizer such as AC, a hard carbon, graphite, graphenes, other non-fibrillizing conductive additives, plasticizers, or combinations thereof. In some applications, a multifunctional CB is combined with AC in a ratio within a range of from about 95:5 to about 50:50.

Other examples utilize a carbon-based additive containing at least two carbon blacks having one or more characteristics that are different form one another, e.g., with respect to their BET. Also possible are blends of carbon blacks with structure-OAN that are different from each other and/or blends of different carbon morphology, i.e., activated carbon or graphite with one or more CBs. At least one component in the blend is a multifunctional CB.

As already noted, many aspects of the invention relate to methods for producing electrode compositions, electrode products (e.g., films), electrodes (in which an electrode product such as a film has been applied onto a conductive substrate), and/or batteries.

Turning first to the dry process employed to prepare the electrode composition described above, performing this process targets at least two objectives: blending some and typically all the constituents, constituents that, in most cases, are provided in the form of loose (e.g., flowing or pourable) particles; and processing the binder in the presence of a multifunctional CB. In some embodiments, each of these two objectives is met by one or more mixing operations conducted under specific shear conditions, using suitable equipment.

A low shear mixing, for example, can be selected to distribute ingredients, as uniformly as possible, for example utilizing a roll mill. As used herein, the term “low shear mixing” refers to mixing conducted under conditions that are not sufficient or not substantially sufficient to fibrillize a fibrillizable binder. Relying on low shear mixing conditions also can avoid excessive particle fragmentations, often a consideration for some electroactive materials.

In many embodiments, processing the binder in the presence of a multifunctional CB is conducted under high shear mixing. As used herein, the term “high shear mixing” refers to shear conditions that are vigorous enough to deform (e.g., elongate, entangle) a binder to a degree sufficient to prepare a film electrode by a solvent-free technique. In the case of fibrillizable binders, high shear mixing refers to mixing under shear conditions that are sufficient to fibrillize the binder.

Without wishing to be bound by a particular interpretation, it is believed that, in the presence of a multifunctional CB additive and under high shear conditions, a binder polymer is deformed, becoming stretched out, elongated and entangled. Surface energy and/or the surface roughness attributes characterizing the CB can facilitate grabbing hold of the binder polymer and the two (CB and polymer) can become squished between electroactive particles, resulting in the binder polymer being stretched out. With CB particles dispersed in the binder or on the surface of the binder, it is thought that CB particles can hold together neighboring polymer domains. Other contributing factors include polymer-polymer interactions (which are expected to increase with increased polymer elongations and/or with multi-directional shear forces), electroactive particles-polymer binder interactions (which can relate to surface energy, and/or other factors.

At the same or substantially the same high shear conditions, these manifestations tend to become more pronounced when the binder employed is a fibrillizable binder. Surface and other CB properties promote snagging the polymer here and there. With all particles moving under high shear mixing, the polymer becomes elongated, forming very long, very thin strands (having a high aspect ratio). Typically, these effects will be less pronounced with a non-fibrillizable binder processed at the same or substantially the same high shear conditions. Or, stated differently, a non-fibrillizable binder may require increased high shear conditions to obtain results approaching full fibrillization.

In addition to the processing contributions described above, the multifunctional CB can enhance electrical conductivity and, in many cases, can act as a mechanical reinforcement by holding together fibrillizable as well as non-fibrillizable polymer binders that are “deformed” (elongated, entangled, etc.) to a full or lesser extent or “undeformed” (globular, rounded, spherical shaped, etc.).

In some situations, high shear mixing also can be relied upon to break particles into smaller fragments. CB larger particles or granules such as CB pellets, for instance, can be comminuted into smaller particles that become uniformly spread throughout the electrode composition, thereby enhancing electrical conductivity and/or mechanical properties.

Specific shear values can depend on the scale of the operation, the materials involved, type of mixing equipment and/or other factors. Low or high mixing settings can be determined or optimized based on prior experience, routine experimentation, and so forth.

Constituents can be combined in any order designed to obtain a mixture, preferably one that is well dispersed, e.g., with a uniform distribution of the constituents, in other words a mixture that is homogeneous. In one example, the CB is homogeneously dispersed on the surface of the electroactive material and the binder.

Binder processing (e.g., fibrillization) can be performed on any mixture or pre-mixture (pre-blend) which brings together the multifunctional CB additive and the binder.

Suitable techniques that can be used or adapted to conduct the steps of mixing and/or binder processing, e.g., fibrillization, include mechanical agitation, shaking, stirring, etc., and can rely on equipment such as jet mills, tube mills, acoustic mixers, extruders, planetary mixers, other mixing devices, e.g., laboratory-scale mixers, equipment suitable for pilot-scale evaluations, for full-scale industrial manufacturing and so forth.

Stepwise sequences can employ one type of apparatus to conduct the first operation (e.g., preparing a pre-blend), and another type of apparatus in the subsequent operation (fibrillization, for instance). The same is true for shear and/or other mixing parameters.

In one embodiment, the CB multifunctional additive is first combined with the binder using high shear equipment to process, e.g., fibrillize, the binder. In some cases, this high shear operation also breaks the CB particles (pelletized granules or other particulates susceptible to comminution under high shear conditions) into smaller fragments. The resulting mixture is then combined with the electroactive material (graphite in one example); use of low shear conditions during this step favors preserving particle size (of the electroactive material, for example).

In another embodiment, the multifunctional CB is first combined with the electroactive material in a pre-blending step conducted under low shear, for example, to obtain a uniform distribution of these two constituents. The binder is then added to this pre-blend and processed, e.g., fibrillized, using high shear conditions.

In a further embodiment, the electrochemical active material, the binder and the multifunctional CB are all mixed (e.g., under low shear conditions); the mixture is then subjected to high shear conditions to process, e.g., fibrillate, the binder.

Other sequences are possible. For instance, the electroactive material can be first mixed with the binder, followed first by the addition of the multifunctional CB additive and then by processing (e.g., fibrillating) the binder under high shear conditions.

Low shear mixing and/or high shear processing (fibrillization, for example) can be conducted in one or more (two, three, four, five, six, etc.) stages or pulses(s) that can last for a suitable period, e.g., withing a range of from about 10 seconds to about 5 minutes, e.g., within a range of from about 30 seconds to about a minute, to about 90 seconds, to about 2 minutes, to about 2.5 minutes, to about 3 minutes, to about 4 minutes, to about 5 minutes; from about 1 minute to about 90 seconds, to about 2 minutes, to about 3 minutes, to about 4 minutes, to about 5 minutes; from about 90 seconds to about 3 minutes, to about 4 minute, to about 5 minutes; from about 2 minutes to about 3 minutes, to about 4 minutes, to about 5 minutes; from about 3 minutes to about 4 minutes, to about 5 minutes; from about 4 minutes to about 5 minutes. Different time intervals also can be employed. The duration of two, more or all pulses can be the same or different.

A pulse can be followed by a rest or a cool-down period. Resting periods can be at ambient, e.g., room temperature. Cooling can be to a temperature below ambient, e.g., below room temperature, often at 0° C. or below, for instance at a temperature within a range of about −5 to about 5° C.

The rest or cooling period can depend on temperatures reached during mixing, quantities handled, and so forth. In many cases, cooling will last for a few minutes, e.g., 10 minutes to half an hour or longer. Cooling periods can differ in duration and/or temperature conditions.

To illustrate, a binder-containing composition can be subjected to a high shear blending at about 25,000 RPM to about 10,000 RPM, optionally at about 18,000 RPM for half a minute, then cooled to a temperature at or below freezing, for 10 minutes, e.g., at about-10° C. A low shear mixing can be conducted at about 2,000 RPM to about 4,000 RPM, for 1 minute followed by a cool down for 10 minutes at about 0° C.

In one example, a pre-blend of a CB multifunctional additive and electroactive material is prepared using an acoustic mixer e.g., for several minutes at 100 G force. The resulting blend is combined with the binder at fibrillization parameters, e.g., using a lab scale jet mill at the pressure rate of 100-90-90-10 psi.

In another example, all components are mixed in a tube mill (such as an IKA TubeMill 100) at 25,000 rpm in a pulsed approach in which blending is alternated with rest periods, followed by a longer duration mixing operation.

Mixing and/or processing, e.g., fibrillization, steps can be monitored by visual inspection, hand calendering, powder rheology, or another suitable technique. For instance, a small amount can be handled manually and sheared or passed through a hand calender. End points can be established based on experience, routine experimentation, visual inspection, and so forth. Whether these operations have been successful also can be determined by SEM, performance and/or other techniques typically conducted on the electrode product, e.g., an electrode film.

The resulting electrode composition (containing, at a minimum, an active electrode material, a multifunctional CB and a deformed, e.g., fibrillized binder) can be in the form of pellets, powders (often fluffy powders), or other forms of free flowing or loose particulate materials.

In an optional step, the electrode composition can be sieved to remove unwanted clumps.

After mixing and processing, e.g., fibrillization, the composition, optionally sieved, can be formed into a product electrode by any suitable technique known in the art or developed in the future. In one implementation, the composition is formed into a film by calendering, an operation which can be conducted at or above room temperature, e.g., at a temperature similar or close to the polymer glass transition temperature. In a typical calendering operation, the electrode composition is subjected to heat and pressure using an extruder. The softened material is passed through calendering rolls (vertical, for instance) to prepare a product electrode sheet or film. In many embodiments, the film is free-standing, a property that can be described using a 150-μm thick film that stands on its own, any part of the film not being in contact with any type of support, e.g., a substrate.

A desired film thickness can be obtained by adjusting the gap between the rolls, and, in some situations, other process parameters.

The roll temperature can be, for example, from about room temperature (20° C.) to about 200° C. High roll temperatures may result in a thinner free-standing film on the first pass, whereas the opposite happens at lower temperature. Roll speed can vary. In illustrative examples, the roll speed is set from about 0.17 meters per minute (m/min) to about 1.3 m/min. A slower roll speed tends to produce a thinner free-standing film on the first pass compared to a faster roll speed. The hydraulic pressure employed can be within a range of from about 1,000 psi to about 7,000. Again, a higher pressure may result in a thinner free-standing film on the first pass compared to the thicker films obtained at a lower pressure.

Additional passes through the roll mill may be employed, reducing the film thickness until the desired thickness and loading are reached. In specific implementations, the film thickness is within a range of form about 40 μm to about 300 μm, e.g., from about 50 to about 200 μm, from about 100 μm to about 150 μm. Also possible are film thicknesses within a range of from 50 to 100, 50 to 150, 50 to 200, 50 to 250; or from 100 to 150, 100 to 200, 100 to 250, 100 to 300; or from 150 to 200, 150 to 250, 150 to 300; or from 200 to 250, from 200 to 300; or from 250 to 300 μm. Desired loadings may be about 10 mg/cm² to about 50 mg/cm².

Free-standing films prepared using a multifunctional CB in a solvent-free process are expected to have good mechanical properties. One mechanical evaluation technique that can be relied upon relates to tensile strength testing. For instance, a graphite anode is expected to have a tensile strength of at least 100 kPa, while the tensile strength of a NCM cathode film is expected to be at least 500 kPa. In one illustrative example, the free-standing film has a tensile strength of at least 0.1 MPa and a thickness ranging from 80 μum to 500 μum. In many cases, the mechanical performance of the film was at least as good as that of a comparative film fabricated using AC.

In an optional operation, the film is thermally activated, e.g., to soften the binder and prepare the electrode product for being applied to a substrate. In the laboratory, this operation can be conducted using a hot plate, at 100° centigrade (C), for instance. Approaches for larger scale processes include temperature-controlled roll to roll calenders, convective and/or microwave driers, and so forth.

The film (typically free-standing and containing active electrode material, a multifunctional CB and a processed, e.g., fibrillized binder) can be applied to a conductive substrate or support (e.g., an aluminum or copper current collector). In one embodiment, the film is laminated to a carbon-coated copper foil by calendering the two together, using, for instance a horizontal hot roller at a suitable roll temperature, roll speed and hydraulic pressure.

The roll temperature can be within the range of from about 80 to about 100° C. Temperatures that are too high can increase blister formation and poor adhesion, while temperatures that are too low can hamper adhesion.

Roll speed may be from about 0.17 m/min to about 1.3 m/min, e.g., about 0.5 m/min, while the hydraulic pressure may be set from about 500 psi to about 2,000 psi. Other settings can be employed. The pressure can be optimized to be high enough to promote adhesion to the substrate without altering loading, porosity or other properties. In some implementations, lamination is performed before setting the final thickness and/or porosity of the film electrode.

The formation of the film and its application to the substrate can be conducted in a single step in some cases. For instance, a powder electrode composition and a substrate foil can be fed together through calendaring rolls under conditions suitable to produce a laminate in which the composition is pressed to film the thickness and adhered to the foil. In this approach, forming a self-standing film is obviated.

The laminated structure can be shaped and/or sized for specific applications such as electrochemical cells, for instance, LIBs, e.g., rechargeable LIBs, and so forth.

Electrodes prepared as described herein can be incorporated into a lithium-ion battery according to methods known in the art, such as, for example, those described in “Lithium Ion Batteries Fundamentals and Applications”, by Yuping Wu, CRC press, (2015). In specific implementations, the batteries are coin type batteries such as, for example, 2032 coin-cells, 18650 cylindrical cells, pouch cells, and others.

In an illustrative example, a LIB includes an anode prepared by a dry process. The anode contains a multifunctional CB, e.g., in an amount no greater than 5 wt %, a graphite (e.g., natural graphite, artificial graphite or blends of both, commercially available types of graphite such as MCMB, MCF, VGCF, MAG, etc.) active anode material and a fibrillized binder. As described above, the graphite active material and fibrillized binder can be present in the anode in an amount of at least 80 wt. % and no more than 5 wt %, respectively.

The second (opposite) electrode in the battery also can be prepared using a solvent-free process. In one implementation, both electrodes in the battery contain a multifunctional CB such as described above.

It is also possible to prepare the second electrode by a conventional dry process (using AC, for instance), by a slurry or by another non-dry technique.

In addition to the two electrodes, the typical LIB comprises a suitable electrolyte. Examples include, for instance, ethylene carbonate-dimethyl carbonate-ethylmethyl carbonate (EC-DMC-EMC), vinylene carbonate (VC), LiPF₆; ethylene carbonate-diethyl carbonate (EC-DEC, LiPF₆; or (EC-DMC), LiPF₆. Furthermore, electrolyte composition may contain special additives known to enhance the performance of SiOₓ or silicon comprising anodes, for example fluorinated carbonates, such as fluoroethylene carbonate and others. In the laboratory, a separator that absorbs electrolyte and prevents electrical contact between electrodes, while allowing diffusion of Li ions, can be a suitable glass fiber micro filter (for example, Whatman GF/A). Membrane separators made of polypropylene/polyethylene (for example, Celgard 2300) also can be used in some cases.

The composition or morphology of electrodes and/or batteries described herein can be characterized by various techniques. Examples include but are not limited to electron microscopy, e.g., TEM, SEM, X-ray tomography, Raman spectrometry, and other suitable qualitative or quantitative analytical methods. In one example, SEM data for graphite electrodes prepared by a dry process using the multifunctional additive described herein revealed the presence of ribbon-like binder fibrils, indicating effective fibrillization.

Solvent amounts or absence thereof can be evaluated by weight testing. This involves drying the wet-casted electrode until electrode weight reaches the value theoretically calculated based on known solids loading of the slurry, or until electrode weight stabilizes and does not change for minimum of 3 min. In the case of an electrode produced entirely in the absence of solvent, the weight remains the same over the evaluation period. Or, stated differently, the weight of the just prepared electrode (before any drying operation) is the same as or within 1 wt % of the theoretical weight (i.e., the weight obtained by adding together the weight of the individual ingredients provided in the process.

Another approach that could be employed to detect a solvent (e.g., NMP) relies on attenuated total reflectance-Fourier transform infrared (ATR-FTIR) spectroscopy (FTIR-ATR), in conjunction with gas chromatography (GC). In many cases, dry-processed electrode films can be distinguished from slurry-based products by very low or undetectable levels of solvent residue. A substantially uniform binder distribution, without binder migration towards a film surface, is yet another feature that often characterizes an electrode product prepared by a solvent-free process.

Flexibility properties characterizing the electrode, (its ability to resist cracking) can be measured by visual inspection upon bending a film by hand or using a Mandrel bend tester. In specific implementations, the electrode is evaluated and expected to pass a 10 mm diameter mandrel bar test without visible cracking to unaided eye. In an illustration, the electrode was found to pass a bending test using a pen of 8 mm diameter as a rod.

Electrode performance can be tested by procedures known in the art, or techniques adapted or developed. Suitable techniques include, for instance, in-plane and thru plane electrode conductivity, electrochemical impedance spectroscopy (EIS), constant current charge-discharge, hybrid pulse power capability (HPPC), cycling.

In many cases, electrodes prepared by a solvent free process, using a multifunctional CB perform at least as well and often better (as measured by in-plane resistivity, initial capacity, or first cycle efficiency, for example) relative to a comparative (also referred to herein as a “reference”) electrode containing the same amounts of active electrode material (e.g., graphite), binder, and a conventional fibrillization agent such as AC. Or, the amounts of multifunctional additive required to reach the performance obtained with AC will typically be lower for electrodes fabricated according to embodiments described herein.

In one illustration, a dry process graphite anode prepared using a multifunctional CB at loadings no higher than about 1 wt %, displayed at least as good a performance (measured by in-plane resistivity, rate capability, 1^{st} cycle efficiency) as a comparative electrode containing higher amounts (e.g., 5 wt %) of AC.

Electrodes prepared using a multifunctional CB in a solvent-free process also are expected to have good mechanical properties. Mechanical evaluation techniques that can be relied upon include peeling testing (e.g., 90°, 180°, T-peel, various fixtures), pull testing, and bending testing (mandrel experiments), to name a few. In many cases, the electrode prepared with a multifunctional CB performed at least as well as a comparative electrode fabricated using AC.

Without wishing to be bound by a specific interpretation, it is believed that using a multifunctional CB such as described herein can produce ribbon-like binder strands or fibrils that can be long enough to wrap around and hold together particles of the electroactive material.

Thus, even at relatively low levels, the multifunctional CB appeared capable of processing, e.g., fibrillating, the binder, generating effective conductive networks in electrodes, while also contributing to desirable mechanical properties.

Compositions and methods described herein also can be used (e.g., incorporated) and/or adapted to the manufacture of other energy storage devices, such as, primary alkaline batteries, primary lithium batteries, nickel metal hydride batteries, sodium batteries, lithium sulfur batteries, lithium air batteries, and supercapacitors. Methods of making such devices are known in the art and are described, for example, in “Battery Reference Book”, by TR Crompton, Newness (2000).

Principles described herein also can be implemented or adapted to semi-dry processes. Such processes often include one step that is a wet (or slurry) step. Other steps are conducted without adding liquid (e.g., solvent).

One illustration of a semi-dry process involves situations in which two or more electrode ingredients, e.g., the electroactive material and a multifunctional CB, for instance, can first be mixed together in a presence of a liquid (e.g., solvent), followed by a drying step to remove the solvent. Remaining operations can then be conducted without adding a liquid (e.g., solvent). For example, the dried pre-blend (containing electroactive material and CB) can be combined with the binder, and the binder processed (e.g., fibrillized), in the absence of liquid, e.g., solvent.

The invention is further illustrated by the following non-limited examples.

### Exemplification

### Materials and Methods

The materials used for the solvent-free electrode process and formulation included Graphite BTR 918-2A from Targray; Lithium nickel manganese cobalt oxide NCM622 (SNCM03006) from Targrey; standard activated carbon of surface area of 1500 cm²/g; electroconductive CB Ketjenblack EC-600J from Lion Co.; C-NERGY™ SUPER C65 carbon black) from Imerys, and acetylene black Li-435 from Denka. All other CB specifications were from Cabot Corporation. The fibrillizable binder was polytetrafluorethylene (PTFE). The physical properties of the carbon blacks employed in the following examples can be found in Tables 1A and 1B above.

Generally, graphite electrodes were prepared in several stages. In a first step (S1) the electrode components were combined and mixed under conditions suitable to fibrillate the binder (e.g., by high shear mixing). The second step (S2) involved passing the powder blend from S1 through a vertical calender pre-set to the appropriate gap based on the desired film thickness. The free-standing films obtained from S2 were laminated onto a current collector in a third step (S3).

A similar sequence of steps was followed to prepare cathode electrodes.

The thickness of the solvent-free electrodes was measured using a manual drop gauge with the flat gauging contact head of 7.14 mm diameter.

The strength and Young's (elastic) modulus of the dry films was measured using the Mecmesin MultiTest-dV motorized force tester with a 10N load.

The sheet resistance of the solvent-free electrodes was measured with a Signatone Pro4-4400 commercial system (SP4 probe head connected to the rear of a Keithley 2410-C source meter). The reported values were normalized by the electrode thickness and reported as electrode resistivity in Ohm·cm.

### Example 1

In this example, free-standing graphite anode films were prepared in 2 steps (S1 and S2) with a jet mill being used as a high shear mixing equipment in S1 and then laminated on current collector to form electrodes (S3).

In S1, electrode components were pre-blended using a Resodyn acoustic mixer (S1-1) and then mixed using a 4-inch Jet mill (S1-2). In more detail, the pre-blending step S1-1 was performed to prepare a uniform distribution of powder components in the blend and included a 5-minute pre-blending of a carbon additive and electrode active material (graphite) in the acoustic mixer at 100% intensity and auto frequency, followed by the addition of the polymer and blending at the same settings for 1 more minute. The next mixing step S1-2 involved fibrillating the binder and included passing a pre-blended material through the lab-scale jet mill at the pressure rate of 100-90-90-10 psi.

In S2, the powder blend obtained in S1 was passed through a vertical calender at room temperature to obtain free-standing films having a thickness between 110 and 190 μm.

In S3, the free-standing electrode films obtained in S2 were thermally activated on a hot plate set to 100° C., then laminated on the carbon-coated, 9-μm thick Copper foil (MTI Corporation) by calendaring them together using a horizontal hot-roller calender pre-heated to 80° C.

The composition of the electrode formulations used (A1 and A2 employed CB, while A3 employed activated carbon and served as reference) are presented in Table A:

TABLE A

| Formulation ID | Active material | Carbon additive | Binder |
|---|---|---|---|
| A1 | 90% Graphite | 5% CB11 | 5% PTFE |
| A2 | 90% Graphite | 5% CB9 | 5% PTFE |
| A3 | 90% Graphite | 5% AC | 5% PTFE |

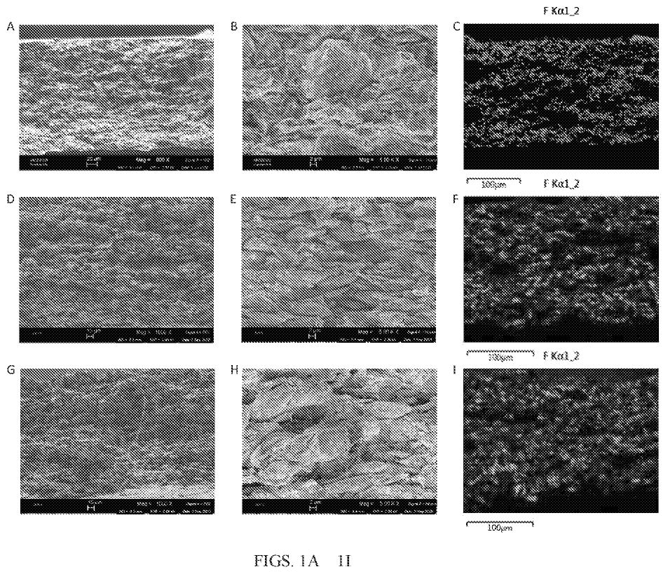

SEM photographs (low and high magnification) and fluorine element mapping of cross-sections of electrode films A1, A2 and A3 as a reference (90% graphite, 5% PTFE, and 5% additive) are presented in FIGS. 1A through 1I.

The binder fibrils can be easily visualized in the formulations with activated carbon (AC), SEM photographs 1A and 1B. Fibrils also are easily observed in electrode A2 (see SEM photographs 1G and 1H). This suggests that certain CBs can function as fibrillizing additives alone, similarly to traditionally used AC, and thus can replace AC in the formulation.

Some fibrils also can be visualized in SEM photographs 1D and 1E of electrode A1, but to a lesser extent than in the case of A2. This supports the idea that surface chemistry matters, and PTFE is more likely to interact with the cleaner surface of the heat-treated material.

FIGS. 1C, 1F and 1I present mappings of elemental fluorine, confirming uniform distribution across the electrode. No migration phenomenon was detected (as is very often the case for slurry-prepared electrodes).

### Example 2

The compositions A1 through A3 in Table A were further tested with respect to the electrical properties of the product. Electrode films were prepared as in Example 1, except that in addition to the combination of acoustic mixer and the jet mill in (S1), the blend was further processed using IKA Tube Mill 100 for 15 sec at 25,000 rpm.

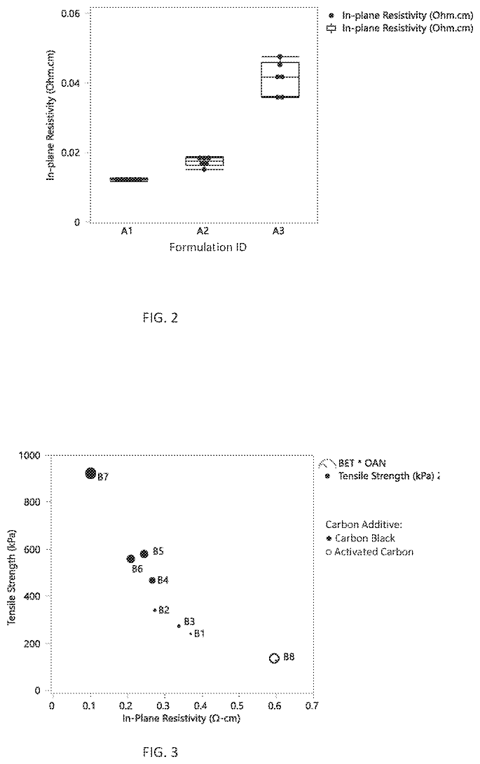

While fibrillization capability of AC and carbon particle CB9 is similar, as seen in Example 1, the CB9 provides the added benefit of lower electrode resistivity when tested at the same loading. As evidenced in FIG. 2, both CB-containing electrodes, namely A1 and A2, showed improved in-plane resistivity compared to the AC-containing reference electrode, namely A3.

Also, since the in-plane resistivity of A2 was almost as low as that of A1, the improved fibrillization observed with A2 may lead to an overall preference for the CB9 (the heat-treated version of CB11), at least in some dry-process applications.

### Example 3

The graphite electrodes in this example were prepared by the same method as in Example 1 except that the jet mill in (S1) was changed to IKA Tube Mill 100, where the electrode components were processed at 25,000 rpm, 6×15 second blending pulses with 45 second rests in-between, followed by 2 minutes of straight blending at 25,000 rpm.

In S2, the powder blend obtained in S1 was passed through a vertical calender at room temperature to obtain free-standing films having a thickness between 120 and 135 μm.

The electrode formulations employed (labeled B1 through B7, with B8 serving as reference) are listed in Table B, below.

TABLE B

| Formulation ID | Active material | Carbon Additive | Binder |
|---|---|---|---|
| B1 | 90% Graphite | 5% CB1 | 5% PTFE |
| B2 | 90% Graphite | 5% CB3 | 5% PTFE |
| B3 | 90% Graphite | 5% CB4 | 5% PTFE |
| B4 | 90% Graphite | 5% CB9 | 5% PTFE |
| B5 | 90% Graphite | 5% CB11 | 5% PTFE |
| B6 | 90% Graphite | 5% CB14 | 5% PTFE |
| B7 | 90% Graphite | 5% CB15 | 5% PTFE |
| B8 | 90% Graphite | 5% AC | 5% PTFE |

FIG. 3 compares the tensile strength of a graphite film and in-plane resistivity of a graphite electrode containing AC (see reference electrode composition B8 in Table B) with electrodes formulated using various CBs, namely additives CB1, CB3, CB4, CB9, CB11, CB14, and CB15 (from Tables 1A and 1B). All electrodes were prepared by a dry process and contained the CB additive at a loading of 5 wt %, graphite (90 wt %) and PTFE (5 wt. %). As seen in FIG. 3, electrodes prepared by a dry process that employed CBs that were thought to provide good binder fibrillization properties (see, e.g., carbon blacks CB9, CB11, CB14, and CB15) also displayed low in-plane resistivities, very comparable or better to the values observed with a good CCA additive such as carbon black CB4 (from Table 1). Furthermore, using CBs that were thought as potentially being good fibrillizers (e.g., carbon blacks CB1, CB3, CB4, CB9, CB11, CB14, and CB15 from Table 1) produced electrodes that displayed lower in-plane resistivities than those seen with AC.

In one example, a free-standing graphite films containing CB3 displayed moderate improvement of tensile strength and in-plain resistivity compared to the data seen with CB4 (not heat treated). This supports the idea that chemistry matters, and PTFE is more likely to interact with the cleaner surface of the heat-treated material CB3.

In another example, a free-standing graphite films containing CB15 (steam-etched) displayed significant improvement of tensile strength and in-plain resistivity compared to those seen with CB4 (not steam-etched). This supports the idea that chemistry and morphology matters, and PTFE is more likely to get fibrilized and more uniformly distributed within the electrode with CB15, which has the cleaner surface, higher surface area, higher structure, and developed meso- and macro-porosity of the steam-etched material.

In addition, since CBs of relatively low surface area (e.g., carbon blacks CB1 and CB3) may cause less solid electrolyte interphase (SEI) formation (growth of SEI being considered a significant factor in LIBs capacity fade) compared to those of relatively high surface area (e.g., carbon blacks CB9, CB11, CB14, CB15), the improved battery performance expected with the lower surface area CB particles may lead to an overall preference for this type of performance additive, at least in some dry process applications.

### Example 4

In this example, free-standing NCM622 cathode films were prepared in 2 steps (S1 and S2) with IKA Tube Mill 100 being used as a high shear mixing equipment in S1 and then laminated on current collector to fabricate electrodes (S3).

In S1, electrode components were pre-blended using a Resodyn acoustic mixer (S1-1) and then mixed using IKA Tube Mill 100 (S1-2). In more detail, the pre-blending step S1-1 was performed to prepare a uniform distribution of powder components in the blend and included a 5-minute pre-blending of a carbon additive and electrode active material (NCM622) in the acoustic mixer at 100% intensity and auto frequency, followed by the addition of the polymer and blending at the same settings for 1 more minute. The next mixing step S1-2 involved fibrillating the binder and included passing a pre-blended material through the IKA Tube Mill 100 at 25,000 rpm, 6×15 second blending pulses with 45 second rests in-between, followed by 3 minutes of straight blending at 5,000 rpm.

In S2, the powder blend obtained in S1 was passed through a vertical calender at 100° C. to obtain free-standing films having a thickness between 110 and 170 μm.

In S3, the free-standing electrode films obtained in S2 were laminated on the carbon-coated aluminum foil current collector by calendaring them together using a vertical hot-roller calender pre-heated to 100° C.

The electrode formulations employed (labeled C1 through C6 and D1 though D6) are listed in Table C and D, respectively:

TABLE C

| Formulation | Active | Carbon | | Free-standing |
|---|---|---|---|---|
| ID | material | Additive | Binder | electrode film |
| C1 | 90% NCM622 | 5% CB1 | 5% PTFE | Failed |
| C2 | 90% NCM622 | 5% CB3 | 5% PTFE | Failed |
| C3 | 90% NCM622 | 5% CB5 | 5% PTFE | Failed |
| C4 | 90% NCM622 | 5% CB9 | 5% PTFE | Pass |
| C5 | 90% NCM622 | 5% CB15 | 5% PTFE | Pass |
| C6 | 90% NCM622 | 5% AC | 5% PTFE | Failed |

TABLE D

| Formulation | Active | Carbon | | Free-standing |
|---|---|---|---|---|
| ID | material | Additive | Binder | electrode film |
| D1 | 94% NCM622 | 2% CB7 | 4% PTFE | Failed |
| D2 | 94% NCM622 | 2% CB8 | 4% PTFE | Failed |
| D3 | 94% NCM622 | 2% CB10 | 4% PTFE | Pass |
| D4 | 94% NCM622 | 2% CB12 | 4% PTFE | Pass |
| D5 | 94% NCM622 | 2% CB13 | 4% PTFE | Pass |
| D6 | 94% NCM622 | 2% CB15 | 4% PTFE | Pass |

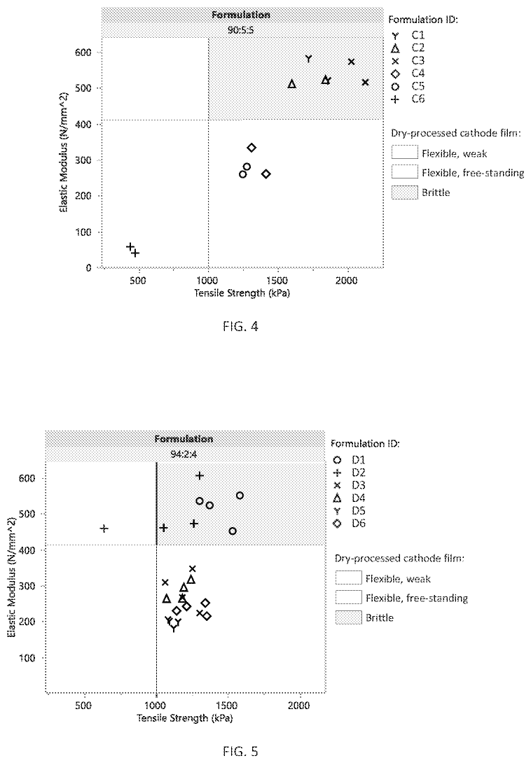

FIG. 4 compares the tensile strength and elastic modulus of a free-standing NCM electrode film containing AC (see reference electrode composition C6 in Table C) with electrodes formulated using various CBs, namely additives CB1, CB3, CB5, CB9, and CB15 (from Tables 1A and 1B). All electrodes were prepared by a dry process and contained the CB additive at a loading of 5 wt %, NCM622 (90 wt %) and PTFE (5 wt. %). As seen in FIG. 4, electrode films prepared by a dry process that employed CBs showed improved strength as compared to the AC-containing reference. In some cases, formulations containing certain CBs, namely CB1, CB3, and CB5, had a relatively high elastic modulus (over 400 N/mm²) and appeared stiff and difficult to process further. In other cases, formulation containing CBs of certain morphology, namely CB9 and CB15, showed a good balance of tensile strength (over 1000 kPa) and elastic modulus (below 400 N/mm²) and formed flexible, free-standing cathode films that passed quality control and were capable of being laminated on current collector.

FIG. 5 compare the tensile strength and elastic modulus of NCM electrode films (see electrode compositions in Table D) formulated using various CBs, namely CB7, CB8, CB10, CB12, CB13, and CB15 (from Tables 1A and 1B). All electrodes were prepared by a dry process and contained the CB additive at a loading of 2 wt %, NCM622 (94 wt %) and PTFE (4 wt. %). Similar to the data in FIG. 4, reported for the formulations of 5 wt. % CB, 90 wt. % NCM622 and 5 wt. % PTFE, CBs of developed morphology, namely CB10, CB12, CB13, and CB15, enabled formation of flexible, free-standing electrode films compared to films obtained with less developed morphology CBs, namely CB7 and CB8. The results are indicative of an overall preference for the relatively high BET, OAN, and pore volume type of the carbon additive, namely CB9, CB10, CB12, CB13, and CB15, to be used as a processing particle, at least in some dry process applications.

As seen in FIG. 6, electrode formulation with carbon black (formulation C4 in FIG. 6) also showed lower electrode resistivity as compared to the AC-containing reference (namely formulation C6); the lower resistivity is known to benefit battery performance.

### Example 5

The NCM cathode electrodes in this example were prepared in 3 steps via formation of a free-standing dry-processed film (S1 and S2) with a twin-screw extruder being used as a high shear mixing equipment followed by its lamination on current collector (S3).

In S1, the dry electrode powder blend was made following a three-stage operation protocol. In more details, in S1-1, three electrode components (NCM622, PTFE, and carbon) were first pre-mixed in powder form in a rolling drum for 30 min for more uniform distribution. In S1-2, the pre-blended powders were processed in a twin-screw extruder at temperature of 100° C., throughput of 3 kg/h, and screw speed of 400 rpm to disperse carbon and fibrillate binder. Finally, the resulting electrode powder blend was in a flake shape. In S1-3, the flaky material obtained in S1-2 was post-processed at low shear in IKA mill at 5000 rpm for 20 seconds to recover its powder form.

In S2, the powder electrode blend obtained in S1 was passed through a vertical calender at 100° C. to obtain a free-standing film. The final dry electrode film thickness was within 110-120 μm range.

In S3, the free-standing electrode films obtained in S2 were laminated on the carbon-coated aluminum foil current collector by calendaring them together using a vertical hot-roller calender pre-heated to 100° C.

The electrode formulations employed (labeled E1 and E2) are listed in Table F, below.

TABLE E

| | | | | Free- |
|---|---|---|---|---|
| | | | | standing |
| | Active | Carbon | | electrode |
| Electrode | material | additive | Binder | film |
| E1 | 97% NCM622 | 1% CB2 | 2% PTFE | Failed |
| E2 | 97% NCM622 | 1% CB12 | 2% PTFE | Pass |
| | | (fluffy form) | | |
| E3 | 97% NCM622 | 1% CB12 | 2% PTFE | Pass |
| | | (pelletized form) | | |

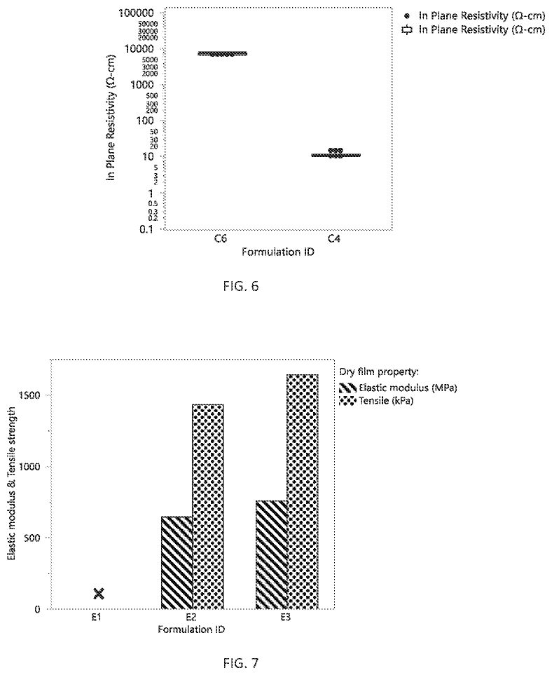

The formulations, namely E1, E2, and E3, produced flakes of similar appearance in S1-2. Upon calendaring (S2), only formulation E2 and E3 produced a free-standing cathode film. The tensile strength and elastic modulus for these films are shown in FIG. 7. The formulation E1 failed to make a free-standing film; rather, it crumbled apart before reaching the targeted thickness of 110 μm. Consequently, no dry process electrodes could be made with formulation E1. This may be indicative of an overall preference for a carbon additive such as CB 12, in either fluffy or pellet form, to be used as a processing particle, at least in some dry process applications.

### Example 6

The graphite electrodes in this example were prepared by the same method as in Example 3 except that in steps (S2), calendaring was done at different temperatures in 2 steps. In one case, to fabricate free-standing films for tensile test testing, the powder blend obtained in S1 was passed through a vertical calender at room temperature first, followed by a second pass through the calender machine pre-heated to 80° C. to obtain free-standing films having a thickness between 250 and 280 μm. In another case, to make dry process electrodes for peeling strength (adhesion) test, the powder blend obtained in S1 was passed through a vertical calender pre-heated to 100° C. as a first step and then at 80° C. as a second step, followed by lamination of the dry film on current collector by passing those together through a vertical calender pre-heated to 80° C.

The electrode formulations employed (labeled F1 through F4) are listed in Table F, below.

TABLE F

| Formulation | Active | Carbon | | Tensile | | Peeling |
|---|---|---|---|---|---|---|
| ID | material | Additive | Binder | strength | | strength |
| F1 | 90% Graphite | 5% Carbon | 5% PTFE | 237 | kPa | 0.035N |
| F2 | 90% Graphite | 5% Carbon | 3.75% PTFE, 1.25% | 187 | kPa | Not |
| | | | PVDF | | | Available |
| F3 | 90% Graphite | 5% Carbon | 2.5% PTFE, 2.5% PVDF | 107 | kPa | 0.089N |

| | | | | | |
|---|---|---|---|---|---|
| F4 | 90% Graphite | 5% Carbon | 5% PVDF | Failed | Failed |

All electrodes were prepared by a dry process and contained the carbon additive at a loading of 5 wt %, graphite (90 wt %) and binder (5 wt. %). As seen in Table F, a free-standing electrode film prepared by a dry process that employed a fibrillizable binder that was expected to stretch and form fibrils easily (see, e.g., PTFE) also displayed higher tensile strength than those with a fibrillizable PTFE binder being partially substituted with a non-fibrillizable binder, namely PVDF (see, e.g., PTFE/PVDF at ratios of 75:25 and 50:50 in formulations F2 and F3, respectively). Furthermore, a formulation containing a non-fibrilizable binder alone (see, e.g., PVDF) did not produce a free-standing film and failed at the first calender pass. On the other hand, partial substitution of PTFE with PVDF in the formulation improved adhesion of the free-standing film to current collector (refer to formulations F3 and F1 in Table F for comparison). This support the idea that while presence of a fibrilizable binder enables dry process electrode formation, non-fibrillizable binders can be used to enhance other electrode characteristics such as, for instance, electrode adhesion to current collector, first cycle irreversibility driven by PTFE performance on the anode side of the battery to name few.

### Example 6

NCM electrodes of two different formulations were made by dry and wet (slurry casting) processes and tested in 2032 half coin cells.

Dry-processed NCM cathodes, namely G1, were prepared by the same method as in Example 4.

Wet-processed NCM cathodes, namely G2, were made following a two-step mixing process with a Thinky ARE310 planetary centrifugal mixer. The first step included a 20-minute mixing (twelve minutes of active mixing) of a carbon conductive additive (CCA)/PVDF/NMP millbase with two small milling tungsten carbide (WC) media. After adding NCM622 powder into the millbase, the second step includes mixing for 20 more minutes (twelve minutes of active mixing) without media. Both NCM and CCA powders were pre-dried at 130° C. for 20 minutes. The electrode slurry was coated on 15-μm thick aluminum foil using an automated doctor blade coater (Model MSK-AFA-III from MTI Corp.). The NMP was evaporated for 20 minutes in a convection oven set at 80° C., and finally dried in a vacuum oven at ˜100° C. The dry electrode loadings were 24.4 mg/cm² on A1 foils, calendered to a density of 3.4 g/cc with a manual roll press.

The electrode formulations employed (labeled G1 and G2, the G2 formulation having been prepared by a slurry (wet) process) and their characteristics are listed in Table F, below. The electrode G2 employed an electrode formulation and displayed electrode characteristics which are standard for NCM cathode in EV application and, thus, served as a baseline.

TABLE G

| | | | Active | | |
|---|---|---|---|---|---|
| | | | material | Electrode | Electrode |
| Electrode | Process | | loading | density | Capacity |
| ID | type | Formulation | [mg/cm²] | [g/cm³] | [mAh/cm²] |
| G1 | Dry | 95% NCM, 2% CB15, 3% PTFE | 33.1 | 3.7 | 5.6 |
| G2 | Wet | 97% NCM, 1.5% CB3, 1.5% PVDF | 24.4 | 3.4 | 3.9 |

The cathodes G1 and G2 (from Table G) were tested in 2032 half coin cells. Fifteen-millimeter-in-diameter discs were punched for coin-cell preparation and dried at 100° C. under vacuum for a minimum of 4 hours. Discs were calendered to a desired density (as shown in Table G) with a manual roll press and assembled into 2032 coin-cells in an argon-filled glove box (M-Braun) for testing against lithium foil. Glass fiber micro filters (Whatman GF/A) were used as separators. The electrolyte was 100 microliters of ethylene carbonate-dimethyl carbonate-ethylmethyl carbonate (EC-DMC-EMC), vinylene carbonate (VC) 1%, LiPF₆ 1M (BASF).

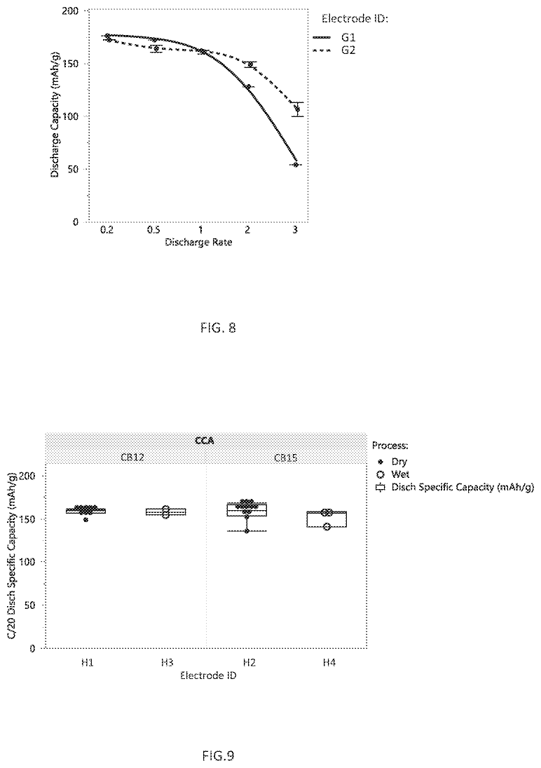

Reported capacities are normalized in mAh/g of active cathode mass. Room temperature (25° C.) performance of the half coin-cells was measured by first forming them using two C/5-D/5 charge-discharge cycles, then charging them at 1C rate and discharging them at C/5, 1C, 2C, and 3C discharge rates. The results (FIG. 8) indicated that the dry-processed G1 formulation had better or comparable capacity at C-rates up to IC (0.2C, 0.5C, and 1.0C) compared to the slurry-processed Baseline formulation G2.

### Example 7

Two set of cathodes were prepared by the same dry and wet (slurry-casting) processes as in Example 6. The electrode formulations employed (labeled H1 though H4, with H3 and H4 serving as a wet process baseline for dry-processed H1 and H2, respectively) and characteristics of the resulting cathodes are listed in Table H, below. All cathodes contained the carbon additive at a loading of 1 wt %, NCM622 (96 wt %) and binder (3 wt. %) prepared with two different carbons, namely C12 and CB15, and calendered at 3.9+0.2 mg/cm² and 3.8+0.1 mg/cm², respectively.

TABLE H

| | | | Active | | |
|---|---|---|---|---|---|
| | | | material | Electrode | Electrode |
| Electrode | Process | | loading | density | Capacity |
| ID | type | Formulation | [mg/cm²] | [g/cm³] | [mAh/cm²] |
| H1 | Dry | 96% NCM, 1% CB12, 3% PTFE | 26.5 | 3.9 | 4.5 |
| H2 | Dry | 96% NCM, 1% CB15, 3% PTFE | 26.2 | 3.8 | 4.5 |
| H3 | Wet | 96% NCM, 1% CB12, 3% PVDF | 26.5 | 3.9 | 4.5 |
| H4 | Wet | 96% NCM, 1% CB15, 3% PVDF | 26.2 | 3.8 | 4.5 |

The cathodes, namely H1, H2, H3, and H4, were tested in 2032 full coin cells. Fifteen-millimeter in diameter discs were punched for coin-cell preparation and dried at 100° C. under vacuum for a minimum of 4 hours. Discs were calendered at the desired electrode density with a manual roll press and assembled into 2032 coin-cells in an argon-filled glove box (M-Braun) for testing against graphite anodes which contained 3% CB, 5% PVDF, 92% natural graphite. Celgard filters were used as separators. The electrolyte was 200 microliters of ethylene carbonate-dimethyl carbonate-ethylmethyl carbonate (EC-DMC-EMC), vinylene carbonate (VC) 1%, LiPF6 1M (BASF).

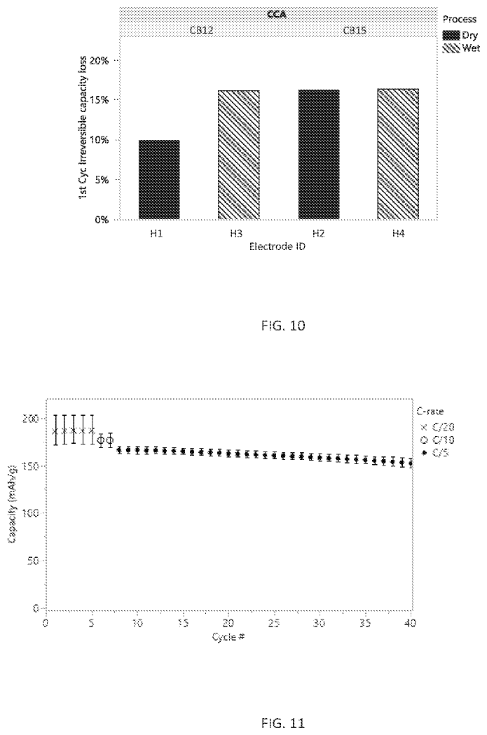

Cells of each formulation were made and measured for initial C/20 capacity and first cycle irreversible loss (FIG. 9 and FIG. 10, respectively). The group of cells for which cathode formulation contained CB12 (from Tables 1A and 1B) and was fabricated by the dry process showed comparable discharge capacity and improved (lower) 1^{st} cycle irreversibility loss compared to those with wet-processed cathodes. The group of cells for which the cathode formulation contained CB15 (from Tables 1A and 1B) and was fabricated by a dry process showed discharge capacity and 1^{st} cycle irreversibility, comparable in both cases to those with wet-processed cathodes. In both cases, performance of dry-processed cathodes remained comparable or better relative to the wet-processed counterparts, indicating that the dry process can replace conventional slurry process without affecting electrochemical performance of the battery.

### Example 8

Dry-processed NCM cathodes containing 2 wt. % CB, namely CB15 (from Tables 1A and 1B), NCM622 (94 wt. %) and PTFE (4 wt. %) were prepared by the same method as in Example 4 and tested in 2032 half coin cells as described in Example 6. The dry cathodes were fabricated at active material loading of 33.5 mg/cm² and capacity of 5.6 mAh/cm² and calendered at 3.6 g/cc.

Cycling performance of the half coin-cells was measured by charging them at +25° C. using 1C charging rate and discharging them at +25° C., using C/20 discharge rate for the first 5 cycles followed by C/10 discharge rate for the next 2 cycles and long-term cycling at C/5. The discharge capacity measured during cycling was close to the theoretical capacity of NCM622, as shown in FIG. 11.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for preparing an electrode composition, the method comprising:
combining an active electrode material, a binder and a multifunctional carbon black; and
processing the binder in the presence of the carbon black, wherein:
the method is conducted without solvent addition; and
the multifunctional carbon black has a BET that is no greater than about 1600 m²/g and an OAN that is no greater than about 650 ml/100 g.

2. The method of claim 1, wherein the active electrode material is graphite and the multifunctional carbon black has a BET within a range of from about 35 to about 1600 m²/g and an OAN within a range of from about 120 to about 650 ml/100 g.

3. (canceled)

4. The method of claim 1, wherein the active electrode material is a lithium transition metal compound and the carbon black has a BET within a range of from about 80 to about 1600 m²/g and an OAN within a range of from about 120 to about 650 ml/100 g.

5-8. (canceled)

9. The method of claim 1, wherein the multifunctional carbon black has one or more of the following properties: a surface energy of about 15 mJ/m² or less, a Raman microcrystalline planar size (Lₐ) of at least about 17 Å, a mesopore volume of at least about 0.35 cm³/g, a total mesopore and macropore volume of at least 1.0 cm³/g and a % crystallinity of at least 22%.

10-16. (canceled)

17. The method of claim 1, wherein the method is conducted in the presence of the multifunctional carbon black as the only fibrillating aid.

18. (canceled)

19. A method further comprising applying the electrode composition prepared according to claim 1 to a conductive substrate, to form a battery electrode.

20. The method of claim 1, further comprising processing the electrode composition to form a free-standing film.

21. (canceled)

22. The method of claim 20, wherein the free-standing film has a tensile strength of at least 0.1 MPa and a thickness within a range of from about 80 and 500 μm.

23. A method for preparing an electrode composition, the method comprising:
combining an active electrode material, a fibrillizable binder and a multifunctional carbon black; and
subjecting the fibrillizable binder to a fibrillization operation in the presence of the multifunctional carbon black, wherein:
the method is conducted in the absence of solvent, and
the multifunctional carbon black has a BET that is no greater than about 1600 m²/g and an OAN that is no greater than about 650 ml/100 g.

24. The method of claim 23, wherein the active electrode material is graphite and the multifunctional carbon black has a BET within a range of from about 35 to about 1600 m²/g and an OAN within a range of from about 120 to about 650 ml/100 g.

25. (canceled)

26. The method of claim 23, wherein the active electrode material is a lithium transition metal compound and the carbon black has a BET within a range of from about 80 to about 1600 m²/g and an OAN within a range of from about 120 to about 650 ml/100 g.

27-30. (canceled)

31. The method of any of claims 23 through 30 claim 23, wherein the multifunctional carbon black has one or more of the following properties: a surface energy of about 15 mJ/m² or less, a Raman microcrystalline planar size (Lₐ) of at least about 17 Å, a mesopore volume of at least about 0.35 cm³/g, a total mesopore and macropore volume of at least 1.0 cm³/g and a % crystallinity of at least 22%.

32-37. (canceled)

38. The method of claim 23, any of claims 23 through 36, wherein the electrode composition contains active electrode material in an amount of from about 90 wt % to about 98 wt %, fibrillizable binder in an amount of from about 1 wt % to about 5 wt % and multifunctional carbon black in an amount of from about 0.3 wt % to about 5 wt %.

39-41. (canceled)

42. A dry processed film electrode comprising: an active electrode material, a processed binder and a multifunctional carbon black, wherein before any drying operation, the film electrode contains solvent residue in an amount no greater than 1 wt % relative to the theoretical weight of the film electrode, wherein the multifunctional carbon black has a BET that is no greater than about 1600 m²/g and an OAN that is no greater than about 650 ml/100 g.

43. The dry processed film of claim 42, wherein the active electrode material is graphite and the multifunctional carbon black has a BET within a range of from about 35 to about 1600 m²/g and an OAN within a range of from about 120 to about 650 ml/100 g.

44. (canceled)

45. The dry processed film of claim 42, wherein the active electrode material is a lithium transition metal compound and the carbon black has a BET within a range of from about 80 to about 1600 m²/g and an OAN within a range of from about 120 to about 650 ml/100 g.

46-49. (canceled)

50. The dry processed film of claim 42, wherein the multifunctional carbon black has one or more of the following properties: a surface energy of about 15 mJ/m² or less, a Raman microcrystalline planar size (La) of at least about 17 Å, a mesopore volume of at least about 0.35 cm³/g, a total mesopore and macropore volume of at least 1.0 cm³/g and a % crystallinity of at least 22%.

51. The dry processed film electrode of claim 42, wherein the multifunctional carbon black is the only fibrillating aid in the film electrode.

52. (canceled)

53. The dry processed film electrode of claim 42, wherein the dry processed film electrode is free standing or laminated to a substrate.

54. A method for preparing an electrode composition, the method comprising:
(a) subjecting a binder to high shear conditions in the presence of a multifunctional carbon black to process the binder; and
(b) adding an electrode active material before, during or after step (a), wherein:
the multifunctional carbon black has a BET that is no greater than about 1500 m²/g and an OAN that is no greater than about 650 ml/100 g, and
the method is conducted without adding a solvent.

55. The method of claim 54, wherein the active electrode material is graphite and the multifunctional carbon black has a BET within a range of from about 35 to about 1600 m²/g and an OAN within a range of from about 120 to about 650 ml/100 g.

56. (canceled)

57. The method of claim 54, wherein the active electrode material is a lithium transition metal compound and the carbon black has a BET within a range of from about 80 to about 1600 m²/g and an OAN within a range of from about 120 to about 650 ml/100 g.

58-61. (canceled)

62. The method of any of claims 54 through 60 claim 54, wherein the multifunctional carbon black has one or more of the following properties: a surface energy of about 15 mJ/m² or less, a Raman microcrystalline planar size (La) of at least about 17 Å, a mesopore volume of at least about 0.35 cm³/g, a total mesopore and macropore volume of at least 1.0 cm³/g and a % crystallinity of at least 22%.

63. The method of any of claims 54 through 61 claim 54, wherein the method is conducted in the presence of the multifunctional carbon black as the only fibrillating aid.
